(19) United States
(12) Patent Application Publication
(10) Pub. No.: US 2026/0025876 A1
(43) Pub. Date: Jan. 22, 2026

(54) METHOD AND APPARATUS FOR PDU SET BASED TRAFFIC MANAGEMENT IN WIRELESS COMMUNICATION SYSTEM

(71) Applicant: Samsung Electronics Co., Ltd., Suwon-si (KR)

(72) Inventors: Jaehyeon BAE, Suwon-si (KR); Youngkyo BAEK, Suwon-si (KR)

(21) Appl. No.: 19/273,766

(22) Filed: Jul. 18, 2025

(30) Foreign Application Priority Data
Jul. 22, 2024 (KR) 10-2024-0096702

(51) Int. Cl. H04W 76/20; H04W 28/02

(52) U.S. Cl. CPC H04W 76/20; H04W 28/0268

(57) ABSTRACT

The disclosure relates to a fifth generation (5G) or sixth generation (6G) communication system for supporting a higher data transmission rate. A method performed by a session management function (SMF) in a communication system is provided. The method includes identifying that a policy and charging control (PCC) rule comprises at least one of first information on a downlink (DL) protocol description or second information on protocol data unit (PDU) set quality of service (QoS) parameters, in case that the PCC rule comprises the first information and does not comprise the second information, transmitting, to a radio access network (RAN), third information associated with a PDU set information marking, and receiving, from the RAN, fourth information indicating that a PDU set based handling is supported.

### CROSS-REFERENCE TO RELATED APPLICATION(S)

This application is based on and claims priority under 35 U.S.C. § 119(a) of a Korean patent application number 10-2024-0096702, filed on Jul. 22, 2024, in the Korean Intellectual Property Office, the disclosure of which is incorporated by reference herein in its entirety.

### BACKGROUND

### 1. Field

The disclosure relates to a wireless communication system. More particularly, the disclosure relates to a method and apparatus for protocol data unit (PDU) set based traffic management in a wireless communication system.

### 2. Description of Related Art

Fifth generation (5G) mobile communication technologies define broad frequency bands such that high transmission rates and new services are possible, and can be implemented not only in “Sub 6 gigahertz (GHz)” bands, such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as Beyond 5G systems) in terahertz (THz) bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) user equipment (UE) power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-operation random access for simplifying random access procedures (2-operation random access channel (RACH) for NR). There also has been ongoing standardization in system architecture/service regarding a 5G baseline architecture (for example, service based architecture or service based interface) for combining network functions virtualization (NV) and software-defined networking (SDN) technologies, and mobile edge computing (MEG) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method or apparatus for using a PDU set based service when separate PDU set quality of service (QoS) parameter information is not transferred from the application function (AF).

Another aspect of the disclosure is to provide a method or apparatus for efficiently using a PDU set based service when a terminal changes a next generation radio access network (NG-RAN) according to the movement of the terminal.

Additional aspects will be set forth in part in the description which follows and, in part, will be apparent from the description, or may be learned by practice of the presented embodiments.

In accordance with an aspect of the disclosure, a method performed by a session management function (SMF) in a communication system is provided. The method includes identifying that a policy and charging control (PCC) rule comprises at least one of first information on a downlink (DL) protocol description or second information on protocol data unit (PDU) set quality of service (QoS) parameters, in case that the PCC rule comprises the first information and does not comprise the second information, transmitting, to a radio access network (RAN), third information associated with a PDU set information marking, and receiving, from the RAN, fourth information indicating that a PDU set based handling is supported.

In accordance with another aspect of the disclosure, a method performed by a radio access network (RAN) in a communication system is provided. The method includes, in case that a policy and charging control (PCC) rule comprises first information on a downlink (DL) protocol description and does not comprise second information on protocol data unit (PDU) set quality of service (QoS) parameters, receiving, from a session management function (SMF), third information associated with a PDU set information marking, and transmitting, to the SMF, fourth information indicating that a PDU set based handling is supported.

In accordance with another aspect of the disclosure, a session management function (SMF) in a communication system is provided. The SMF includes at least one transceiver, at least one processor communicatively coupled to the at least one transceiver, and at least one memory, communicatively coupled to the at least one processor, storing instructions executable by the at least one processor individually or in any combination to cause the SMF to identify that a policy and charging control (PCC) rule comprises at least one of first information on a downlink (DL) protocol description or second information on protocol data unit (PDU) set quality of service (QoS) parameters, in case that the PCC rule comprises the first information and does not comprise the second information, transmit, to a radio access network (RAN), third information associated with a PDU set information marking, and receive, from the RAN, fourth information indicating that a PDU set based handling is supported.

In accordance with another aspect of the disclosure, a radio access network (RAN) in a communication system is provided. The RAN includes at least one transceiver, at least one processor communicatively coupled to the at least one transceiver, and at least one memory, communicatively coupled to the at least one processor, storing instructions executable by the at least one processor individually or in any combination to cause the RAN to, in case that a policy and charging control (PCC) rule comprises first information on a downlink (DL) protocol description and does not comprise second information on protocol data unit (PDU) set quality of service (QoS) parameters, receive, from a session management function (SMF), third information associated with a PDU set information marking, and transmit, to the SMF, fourth information indicating that a PDU set based handling is supported.

According to an embodiment of the present disclosure, a method performed by a session management function (SMF) entity in a wireless communication system may include: receiving a PDU set QoS parameter including only PDU set integrated handling indication (PSIHI) information with a PSIHI value set to false according to downlink packet-related characteristic information (protocol description) and/or a provider policy, or the like, from a policy control function (PCF) via policy and charging control (PCC) rule information, determining (or determining PDU set based packet handling support without PDU set QoS parameter information) PDU set based packet handling support transferred from an AF based on the PCC rule information that includes the PDU set QoS parameter including only the PSIHI information with the PSIHI value set to false and/or a PDU set based handling allowance indicator according to downlink packet-related characteristic information (protocol description) and/or the provider policy, or the like, when only the PDU set based handling allowance indicator is received from a PCF, generating the PDU set QoS parameter including only the PSIHI information with the PSIHI value set to false or generating information (e.g., PDU set based handling allowance indicator) indicating that the PDU set based packet handling is supported, transferring the PDU set based packet handling allowance information (the PDU set QoS parameter including only the PSIHI information with the PSIHI value set to false or the PDU set based handling allowance indicator) to an NG-RAN, receiving information (e.g., PDU set based handling/marking request or PDU set based handling indicator (when the PDU set QoS parameter including only the PSIHI information with the PSIHI value set to false is transferred from the SMF to the NG-RAN)) requesting PDU set based packet handling from the NG-RAN, and generating PDU set information based on the information requesting the PDU set based packet handling received from the NG-RAN and transferring an indicator and related information for performing a marking operation on the corresponding PDU set information in a general packet radio service (GPRS) tunneling protocol-user plane (GTP-U) extension header to a user plane function (UPF) via an N4 rule.

The disclosure relates to a 5G or 6G communication system for supporting a higher data transmission rate. The disclosure relates to a 5G or 6G communication system for supporting a PDU set based packet handling service that does not utilize PDU set QoS parameter information according to the provider policy or configuration in the separate SMF and PCF (without PDU set QoS parameter information) via the AF, or the like.

A method performed by a session management function (SMF) entity in a wireless communication system may include: receiving a PDU set QoS parameter including only PSIHI information with a PSIHI value set to false, a PDU set based handling allowance indicator, or the like, according to downlink packet-related characteristic information (protocol description) and/or a provider policy, or the like, from a PCF via PCC rule information, determining a PDU set based packet handling support based on the PCC rule information that includes the PDU set QoS parameter including only the PSIHI information with the PSIHI value set to false and/or the PDU set based handling allowance indicator, or the like, according to the downlink packet-related characteristic information (protocol description) and/or the provider policy, or the like, when only the PDU set based handling allowance indicator is transferred, determining whether to generate the PDU set QoS parameter including only the PSIHI information with the PSIHI value set to false, transferring, to an NG-RAN, the PDU set QoS parameter including only the PSIHI information with the PSIHI value set to false or information (e.g., the PDU set based handling allowance indicator) indicating that PDU set based packet handling is supported, receiving information (e.g., PDU set based handling/marking request or PDU set based handling indicator (when the PDU set QoS parameter including only the PSIHI information with the PSIHI value set to false is transferred from the SMF)) requesting PDU set based packet handling from the NG-RAN, and generating PDU set information based on the information requesting the PDU set based packet handling received from the NG-RAN and transferring an indicator and related information for performing a marking operation on the corresponding PDU set information in a GTP-U extension header to a UPF via an N4 rule.

According to an embodiment of the disclosure, it is possible for a terminal to efficiently use a PDU set based service.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram illustrating a network architecture and interface of a 5G system according to an embodiment of the disclosure;

FIG. 2 is a diagram related to support of a handover operation according to movement of a UE when using a service supporting PDU set based packet handling according to an embodiment of the disclosure;

FIGS. 3A_1, 3A_2, and 3B illustrate requesting a service supporting PDU set based packet handling from an NG-RAN according to various embodiments of the disclosure;

FIGS. 4A and 4B illustrate supporting an Xn handover operation according to a movement of a UE when using a service supporting a PDU set based packet handling according to various embodiments of the disclosure;

FIGS. 5A and 5B illustrate supporting an N2 handover operation according to a movement of a UE when using a service supporting a PDU set based packet handling according to various embodiments of the disclosure;

FIGS. 6A_1, 6A_2, and 6B illustrate supporting a N2 handover operation to which I-SMF selection and insertion operations are added according to a movement of the UE when using a service supporting a PDU set based packet handling according to various embodiments of the disclosure;

FIG. 7 is a diagram illustrating a structure of a terminal according to an embodiment of the disclosure; and

FIG. 8 is a diagram illustrating a structure of a base station according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The third generation partership project (3GPP), responsible for cellular communication standards, is standardizing a new core network architecture named the 5G core (5GC) to facilitate the evolution from fourth generation (4G) long-term evolution (LTE) systems to 5G systems. The 5GC may support the following differentiated functions compared to an evolved packet core (EPC), which is a network core for 4G.

The 5GC introduces a network slice function. As the requirement of the 5G, the 5GC should support various kinds of UE types and services. Examples of the 5G may include enhanced mobile broadband (eMBB), ultra reliable low latency communications (URLLC), and massive machine type communications (mMTC). Each of the UE/service may have different requirements for the core network. For example, eMBB services may require a high data rate, while URLLC services may require high stability and low delay. To satisfy these various service requirements, network slice technology has been proposed.

The network slicing may mean a method of creating multiple logical networks (e.g., network slices) by virtualizing a single physical network. An activated network slice may be called a network slice instance (NSI), and each network slice instance may have different characteristics. By configuring a network function (NF) for each NSI according to characteristics of the NSI, a mobile communication provider may satisfy various service requirements according to the UE/service. For example, the mobile communication provider may efficiently support multiple 5G services (e.g., eMBB, URLLC, or mMTC) by allocating the NSI according to characteristics of services required for each UE.

The 5GC may easily support a network virtualization paradigm by separating a mobility management function and a session management function. In the 4G LTE, all UEs may receive services from the network via signaling exchange with a single core entity called mobility management entity (MME), which is responsible for registration, authentication, mobility management, and session management functions. In the 5G, as the number of UEs (e.g., including MTC UEs) increases explosively and mobility and traffic/session characteristics, which should be supported according to the type of UEs, are subdivided, if a single entity (e.g., MME) supports all functions, the scalability of adding entities for each required function may be bound to decrease. Therefore, various functions are being developed based on a structure that separates the mobility management function and the session management function in order to improve the scalability in terms of the functional/implementation complexity and signaling load of a core entity responsible for a control plane.

Hereinafter, an embodiment of the disclosure will be described with the accompanying drawings. In addition, in describing the disclosure, when it is determined that a detailed description for known functions or configurations related to the disclosure may unnecessarily obscure the gist of the disclosure, the detailed description thereof will be omitted. Further, the following terms are defined based on the functions in the disclosure and may be construed in different ways by the intention of users and providers, customs and the like. Therefore, the definitions thereof should be construed based on the contents throughout the specification.

For the same reason, some components in the accompanying drawings are exaggerated, omitted, or schematically illustrated. In addition, the size of each component does not entirely reflect the actual size. The same or corresponding components in each drawing may be assigned the same reference numbers.

Various advantages and features of the technical idea according to the disclosure and methods accomplishing them will become apparent from the following description of embodiments with reference to the accompanying drawings. However, the disclosure is not limited to embodiments to be described below, but may be implemented in various different forms, these embodiments will be provided only in order to make the disclosure complete and allow those skilled in the art to completely recognize the scope of the disclosure, and the disclosure will be defined by the scope of the claims. Throughout the specification, like reference numerals may denote like components.

Hereinafter, a base station is an entity that performs resource allocation for a UE, and may be at least one of an eNode B, a Node B, a base station (BS), a radio access network (RAN), an access network (AN), a RAN node, a radio access unit, a base station controller, or a node on a network. The terminal may include user equipment (UE), a mobile station (MS), a cellular phone, a smartphone, a computer, or a multimedia system capable of performing a communication function. In the disclosure, downlink (DL) refers to a wireless transmission path of a signal that the base station transmits to the UE, and uplink (UL) refers to a wireless transmission path of a signal that the UE transmits to the base station.

In addition, although one or more embodiments of the disclosure may be described below using long term evolution (LTE), LTE-advanced (LTE-A) or 5th-generation (5G) systems as one example, one or more embodiments of the disclosure may be applied to other communication systems having similar technical backgrounds or channel types. For example, the 5th generation mobile communication technology (5G, new radio (NR)) developed after the LTE-A may be included in the system to which the embodiments of the disclosure may be applied, and the 5G below may be a concept that includes the existing LTE, LTE-A, and other similar services. In addition, embodiments of the disclosure may be applied to other communication systems with some modifications, as determined by those skilled in the art, without significantly departing from the scope of the disclosure.

It will be appreciated that each block of a processing flowchart and combinations of the flowcharts may be executed by computer program instructions. Since these computer program instructions may be mounted in a processor of a general computer, a special computer, or other programmable data processing apparatuses, these computer program instructions executed by the processor of the computer or the other programmable data processing apparatuses create means performing functions described in a block (s) of the flow chart. Since these computer program instructions may also be stored in computer usable or computer readable memory that may be directed to a computer or other programmable data processing apparatuses in order to implement the functions in a specific scheme, the computer program instructions stored in the computer usable or computer readable memory can also produce manufacturing articles including instruction means performing the functions described in the block(s) of the flowchart. Since the computer program instructions may also be mounted on the computer or the other programmable data processing apparatuses, the instructions performing a series of operations on the computer or the other programmable data processing apparatuses to create processes executed by the computer, thereby executing the computer or the other programmable data processing apparatuses may also provide operations for performing the functions described in a block(s) of the flowchart.

In addition, each block may indicate some of modules, segments, or codes including one or more executable instructions for executing a specific logical function(s). Further, it is to be noted that functions mentioned in the blocks occur regardless of a sequence in some alternative embodiments. For example, two blocks that are continuously illustrated can be simultaneously performed substantially or be performed in a reverse sequence.

The term “˜unit” used in the embodiments of the disclosure means a software or hardware component, such as a field programmable gate array (FPGA) or an application specific integrated circuit (ASIC), and the “˜unit” may perform certain roles. However, the “˜unit” is not meant to be limited to software or hardware. The “˜unit” may be configured to be stored in a storage medium that can be addressed or may be configured to play one or more processors. Therefore, as an example, the “˜unit” includes components, such as software components, object-oriented software components, class components and task components, processes, functions, attributes, procedures, subroutines, segments of program code, drivers, firmware, microcode, circuits, data, databases, data structures, tables, arrays, and variables. Components and functions provided within “˜unit” may be combined into a smaller number of components and “˜unit” or may be further separated into additional components and “˜unit.” In addition, components and “˜units” may be implemented to play one or more CPUs in a device or a secure multimedia card. In addition, in an embodiment of the disclosure, “˜unit” may include one or more processors.

In the case of metaverse and XR applications, since a UE should transmit and receive a large amount of traffic, effectively processing traffic should address important technical problems, unlike the existing applications. Unlike the existing studies that primarily focused on effectively transmitting application server traffic to UEs, metaverse/XR traffic poses a new challenge of efficiently processing a large amount of traffic and diverse service flow characteristics

In the case of the metaverse and XR applications, a large amount of data should be transmitted, and a scheme for reducing the occurrence of network congestion may be applied for effective scheduling. To this end, in extended reality and media service (XRM), a scheme for protocol data unit (PDU)-level data forwarding and processing by considering of characteristics in a flow has been introduced in a user plane function (UPF) to enable efficient scheduling beyond the existing concept of simple 5-tuple-based flow-level data forwarding. In an application layer, PDUs with similar characteristics may be grouped into a logical unit called a PDU set for PDU-level data forwarding and processing.

An embodiment of the disclosure may propose a scheme for providing information on requirements related to characteristics of data traffic in a multiplexed service flow to a control plane to support quality of service (QoS) processing according to characteristics of each data traffic when scheduling the data traffic in the multiplexed service flow, which is transferred from an application server or a UE, in a RAN according to the characteristics of the data traffic based on network conditions and requests, and providing information on the time point when data characteristics in the multiplexed service flow change during real-time data transmission of the multiplexed service flow and the related information by including the related information in PDU set information in a real-time transport protocol (RTP) header extension information to additionally support PDU set based data traffic processing and QoS processing according to the characteristics of the data traffic, thereby performing accurate processing when processing data in units of PDU sets in a UPF.

In an embodiment of the disclosure, by performing a process of receiving a PDU set based QoS parameter from an AF, transferring the PDU set based QoS parameter to an NG-RAN via the PCF and an SMF, and receiving whether to support PDU set based handling in the NG-RAN in order for a service to support the existing PDU set based QoS handling, a PDU set based QoS handling operation may be performed. However, depending on the configuration of the service provider or the support availability of the server, a separate PDU set QoS parameter may not be transferred from the AF, but the PCF or the SMF may determine whether to support the PDU set based QoS handling without the PDU set QoS parameter based on the configuration information or the provider policy. The SMF may transfer information on whether to support PDU set based traffic handling without the PDU set based QoS parameter to the NG-RAN based on information (e.g., PDU set based handling allowance indicator or PDU set QoS parameter with a PSIHI value set to false) on whether the PDU set based handling is supported. For a PDU set based service request without a PDU set QoS parameter, the NG-RAN transfers PDU set based handling request information (e.g., PDU set based handling/marking request or PDU set based handling indicator) to the SMF, and the SMF that receives the PDU set based service request may transfer, to the UPF, an N4 rule including operation instruction information for generating the PDU set information and marking the generated PDU set information in a GTP-U extension header. Based on the operation, a PDU set based service may be used even when separate PDU set QoS parameter information is not transferred from the AF.

In addition, when the change in the NG-RAN occurs according to the movement of the UE, the PDU set based handling request information (e.g., the PDU set based handling/marking request or the PDU set based handling indicator) and/or separate information (e.g., the PDU set based handling allowance indicator) on whether to support the PDU set based handling received from the SMF may be included in a handover request message transferred from a source NG-RAN to a target NG-RAN or an AMF. When a PDU set based handling or marking request is performed during a specific time when a congestion situation occurs, PDU set based handling/marking timer information may be additionally included in the handover request message. By using the information, the UE may continue to use the PDU set based service without separate configuration or change even when the NG-RAN changes according to the movement of the UE.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

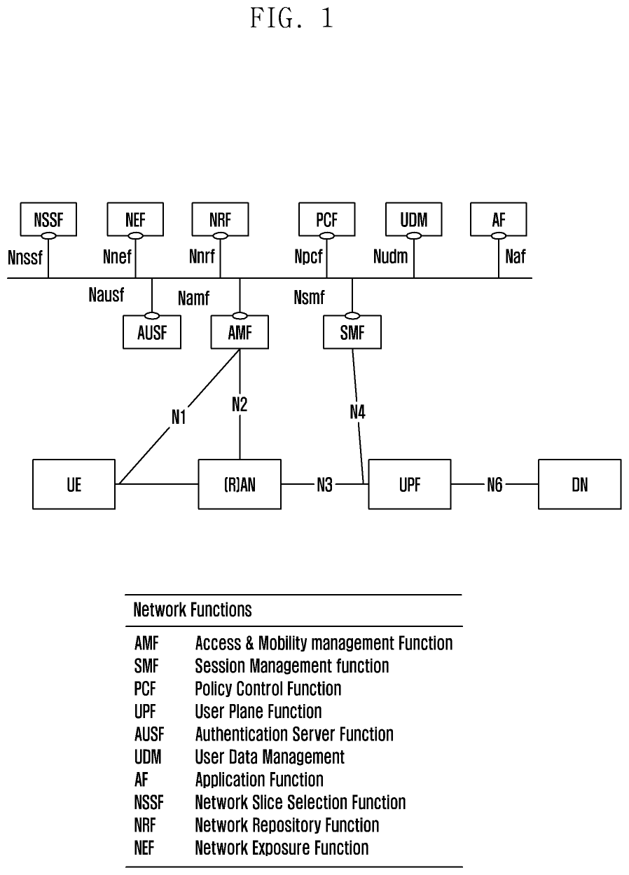

FIG. 1 is a diagram illustrating a network architecture and interface of a 5G system according to an embodiment of the disclosure.

A network entity included in the network architecture of the 5G system of FIG. 1 may include a network function (NF) according to the system implementation.

Referring to FIG. 1, the network architecture of the 5G system may include various network entities. For example, the 5G system may include an authentication server function (AUSF), an (core) access and mobility management function (AMF), a session management function (SMF), a policy control function (PCF), an application function (AF), a unified data management (UDM), a data network (DN), a network exposure function (NEF), an edge application service domain repository (EDR), an edge application server (EAS), an EAS discovery function (EASDF), a user plane function (UPF), a (radio) access network ((R)AN), and a UE, i.e., user equipment (UE).

Each NF of the 5G system may support the following functions.

The AUSF may process and store data for authentication of the UE.

The AMF provides functions for connection and mobility management per UE, and one UE may be basically connected to one AMF. Specifically, the AMF may support signaling between core network (CN) nodes for mobility between 3GPP access networks, termination of a radio access network (RAN) control plane (CP) interface (i.e., N2 interface), termination (N1) of non access stratum (NAS) signaling, NAS signaling security (NAS ciphering and integrity protection), access stratum (AS) security control, registration management (registration area management), connection management, idle mode UE reachability (including control and performance of paging retransmission), mobility management control (subscription and policy), support for intra-system mobility and inter-system mobility, support for network slicing, and SMF selection. In addition, the AMF may support functions, such as lawful intercept (LI) (for AMF events and interfaces to LI systems), providing transfer of session management (SM) message between a UE and an SMF, transparent proxy for SM message routing, access authentication, access authorization including roaming authorization check, providing transfer of an SMS message between a UE and a short message service function (SMSF), a security anchor function (SAF) and/or security context management (SCM). Some or all of the functions of the AMF may be supported within a single instance of one AMF.

The DN may represent, for example, a provider service, an Internet connection, a 3^{rd} party service, or the like. The DN may transmit a downlink protocol data unit (PDU) to the UPF or receive the PDU transmitted from the UE from the UPF.

The PCF may receive information on a packet flow from an application server and provide functions to determine policies, such as mobility management and session management. Specifically, the PCF may support functions, such as supporting a unified policy framework for controlling a network operation, providing policy rules so that control plane function(s) (e.g., AMF, SMF, or the like) may enforce the policy rules, and implementing a front end for accessing related subscription information for policy determination in a user data repository (UDR).

The SMF provides the session management function, and when the UE has multiple sessions, each session may be managed by a different SMF. Specifically, the SMF may support session management (e.g., session establishment, modification, and disconnect, including tunnel maintenance between the UPF and (R)AN nodes), UE IP address allocation and management (optionally including authentication), selection and control of a UP function, traffic steering setup to route traffic from the UPF to appropriate destinations, termination of interfaces to policy control functions, enforcement of control portions of policy and quality of service (QoS), and lawful intercept (for SM events and interfaces to LI systems). In addition, the SMF may also support function, such as termination of an SM portion of a NAS message, downlink data notification, initiation of AN specific SM information (transfer to (R)AN via N2 via AMF), determination of SSC mode of sessions, and roaming functions. Some or all of the functions of the SMF may be supported within a single instance of one SMF.

The UDM stores user subscription data, policy data, or the like. The UDM may include two parts: application front end (FE) and user data repository (UDR).

The FE may include a UDM FE responsible for location management, subscription management, credential processing, or the like, and the PCF responsible for policy control. The UDR may store data required for functions provided by a UDM-FE and policy profiles required by the PCF. The data stored in the UDR may include user subscription data and policy data that include a subscription identifier, security credential, access and mobility-related subscription data, and session-related subscription data. The UDM-FE may access subscription information stored in the UDR and support functions, such as authentication credential processing, user identification handling, access authentication, registration/mobility management, subscription management, and SMS management.

The UPF may transfer a downlink PDU received from the DN to the UE via the (R)AN, and transfer an uplink PDU received from the UE via the (R)AN to the DN. Specifically, the UPF may support an anchor point for intra/inter RAT mobility, an external PDU session point for interconnect to a data network, packet routing and forwarding, a user plane portion of packet inspection and policy rule enforcement, lawful intercept, traffic usage reporting, and an uplink classifier to support routing of a traffic flow to the data network. In addition, the UPF may support functions, such as a branching point to support multi-homed PDU sessions, QoS handling (e.g., packet filtering, gating, uplink/downlink rate enforcement) for the user plane, uplink traffic validation (SDF mapping between service data flow (SDF) to QoS flow), transfer level packet marking in uplink and downlink, downlink packet buffering, and downlink data notification triggering. Some or all of the functions of the UPF may be supported within a single instance of one UPF.

The AF may interoperate with the 3GPP core network to provide services (e.g., to support functions, such as application influence on traffic routing, access to network capability exposure, and interaction with a policy framework for policy control).

The (R)AN may collectively refer to a new radio access network that supports both evolved E-UTRA (E-UTRA) which is an evolved version of 4G radio access technology, and new radio access technology (new radio (NR)) (e.g., gNB).

The gNB may support functions for radio resource management (e.g., radio bearer control, radio admission control, connection mobility control, dynamic allocation of resources to a UE in uplink/downlink (i.e., scheduling)), internet protocol (IP) header compression, encryption and integrity protection of user data stream, selection of the AMF upon UE attachment when routing to the AMF is not determined from information provided to the UE, routing of user plane data to the UPF(s), routing of control plane information to the AMF, and connection setup and disconnect. In addition, the gNB may support functions, such as scheduling and transmission of a paging message (generated from AMF), scheduling and transmission of system broadcast information (generated from AMF or operating and maintenance (O&M)), measurement and measurement reporting configuration for mobility and scheduling, transport level packet marking in uplink, session management, support for network slicing, QoS flow management and mapping to data radio bearers, support for a UE in inactive mode, a distribution function of NAS message, a NAS node selection function, sharing of radio access networks, dual connectivity, and tight interworking between NR and E-UTRA.

The UE may mean user equipment. The user device may be referred to by terms, such as a terminal, mobile equipment (ME), and a mobile station (MS). In addition, the user device may be portable devices, such as a laptop, a mobile phone, a personal digital assistant (PDA), a smart phone, a multimedia device, or non-portable devices, such as a personal computer (PC) or a vehicle-mounted device.

The NEF may provide a means to securely expose services and capabilities, such as 3^{rd} party, internal exposure/re-exposure, application functions, and edge computing that are provided by 3GPP network functions. The NEF may receive information from other NF(s) (based on the exposed capability(s) of other NF(s)). The NEF may store the received information as structured data using a standardized interface to a data storage network function. The stored information may be re-exposed by the NEF to other NF(s) and AF(s) and may be used for other purposes, such as analytics.

The EASDF may be an NF that may add an EDNS client subnet (ECS) option per fully qualified domain name (FQDN), where the ECS option may be expressed as an address of a DNS server to which a domain name system (DNS) request of a UE will be forwarded and an IP subnet address to be added when forwarding the DNS request of the UE. The EASDF may receive EAS domain configuration information from EDR, and may process a DNS request message received from the UE according to the received information.

In addition, the EASDF may be an NF that performs a function of receiving a UE IP address and location information of the UE within the 3GPP, and a DNS message processing rule and a DNS message reporting rule from the SMF, processes a DNS query message received from the UE and a DNS response message received from a DNS server, and transmitting information in the DNS message and statistical information obtained by processing the information in the DNS message to the SMF according to the DNS message reporting rule. The NRF may support a service discovery function. The NRF may receive an NF discovery request from an NF instance and provide information on the discovered NF instance to the NF instance. In addition, the NRF may maintain available NF instances and services the NF instances support.

Meanwhile, for convenience of description, FIG. 1 illustrates a reference model for a case where a UE accesses one DN using one PDU session, but the disclosure is not limited thereto.

The UE may access two (i.e., local and central) data networks simultaneously using multiple PDU sessions. In this case, two the SMFs may be selected for different PDU sessions. However, each SMF may have the capability to control both the local UPF and the central UPF within the PDU session.

In addition, the UE may also access two (i.e., local and central) data networks provided within a single PDU session simultaneously.

In the 3GPP system, a conceptual link connecting the NFs within the 5G system may be defined as a reference point. As an example, the reference point(s) included in the 5G system of FIG. 1 are as follows.
N1: Reference point between UE and AMF
N2: Reference point between (R)AN and AMF
N3: Reference point between (R)AN and UPF
N4: Reference point between SMF and UPF
N5: Reference point between PCF and AF
N6: Reference point between UPF and DN
N7: Reference point between SMF and PCF
N8: Reference point between UDM and AMF
N9: Reference point between two core UPFs
N10: Reference point between UDM and SMF
N11: Reference point between AMF and SMF
N12: Reference point between AMF and AUSF
N13: Reference point between UDM and AUSF
N14: Reference point between two AMFs
N15: Reference point between PCF and AMF in case of non-roaming scenario, reference point between PCF and AMF in visited network in case of roaming scenario
Nx: Reference point between SMF and EASDF
Ny: Reference point between NEF (EDF) and EASDF

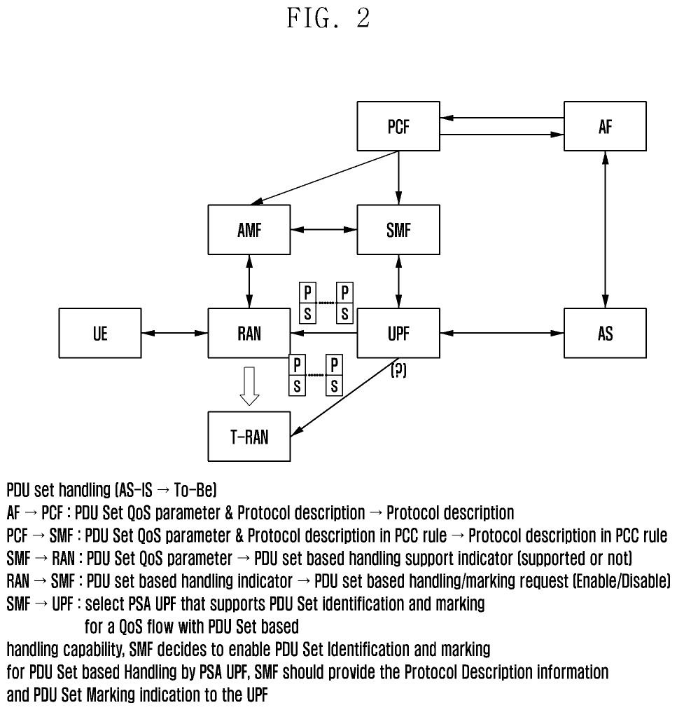

FIG. 2 illustrates support of a handover operation according to movement of a UE when using a service supporting PDU set based packet handling according to an embodiment of the disclosure.

Referring to FIG. 2, according to an embodiment of the disclosure, a PDU set may be exemplified as a group or set of one or more PDUs having the same characteristics.

According to an embodiment of the disclosure, the PCF, which has not received the PDU set QoS parameter from the AF but has received related information that may generate PDU set based information, such as protocol description, may generate a PDU set QoS parameter with a PDU set integrated handling indication (PSIHI) value set to false based on a policy or configuration of a network provider, or the like, or the SMF, which has received the related information that may generate the PDU set based information, such as the protocol description, may separately generate the information (e.g., the PDU set based handling allowance indicator and/or the PDU set QoS parameter that includes only a value where a PSIHI value is set to false) on whether to support the PDU set based handling and transfer the generated PDU set based information to the NG-RAN.

Hereinafter, examples of the information on whether to support the PDU set based handling that may be generated in the SMF according to an embodiment of the disclosure may be exemplified as the PDU set based handling allowance indicator, the PDU set QoS parameter that includes only the value where the PSIHI value is set to false, or the PDU set based handling support indicator, or the like. In addition, the PDU set based handling allowance indicator may be used instead of the PDU set based handling support indicator in the drawings for related expressions.

In addition, according to an embodiment of the disclosure, the PCF may transmit, to the SMF, a PCC rule the includes the generation of the PDU set QoS parameter information where the PSIHI value is set to false and/or the PDU set based handling allowance indicator. In addition, when the SMF that has received the PCC rule including the PDU set based handling allowance indicator from the PCF fails to generate the PDU set QoS parameter information where the PSIHI value is set to false in the SMF according to the provider configuration, or the like, the SMF may transmit the separate information on whether to support PDU set based handling to the NG-RAN.

According to an embodiment of the disclosure, the PCF may determine whether to allow the PDU set based handling even when the PDU set QoS parameter is not transferred from the AF according to the provider policy or configuration. In addition, the PCF may determine whether to generate the PDU set QoS parameter information with the PSIHI value set to false when the PDU set QoS parameter is not transferred from the AF according to the provider policy or configuration. When the PCF generates the PDU set QoS parameter information with the PSIHI value set to false, the PCF may generate the PCC rule including the corresponding value and information (PDU set based handling allowance indicator) on whether to allow the PDU set based handling and transfer the PCC rule to the SMF. When the PCF fails to generate the PDU set QoS parameter with the PSIHI value set to false, the PCF may transfer the PCC rule including only the information (PDU set based handling allowance indicator) on whether to allow the PDU set based handling to the SMF.

According to an embodiment of the disclosure, the SMF that has received the PCC rule including the PDU set QoS parameter information with the PSIHI value set to false and/or the information (PDU set based handling allowance indicator) on whether to allow the PDU set based handling may perform an operation of generating and transferring information for supporting the PDU set based service without the PDU set QoS parameter. When the information (PDU set based handling allowance indicator) on whether to allow the PDU set based handling and the PDU set QoS parameter information with the PSIHI value set to false are transferred in the PCC rule transferred from the PCF, the SMF may transmit the PDU set QoS parameter information with the PSIHI value set to false to the NG-RAN. However, when the PCC rule transferred from the PCF includes only the information (PDU set based handling allowance indicator) on whether to allow the PDU set based handling, the SMF may generate the PDU set QoS parameter information with the PSIHI value set to false or generate the separate information on whether to support the PDU set based handling and transmit the generated PDU set QoS parameter information or the generate separate PDU set based handling support information to the NG-RAN according to the provider policy or configuration.

According to an embodiment of the disclosure, the NG-RAN, which has received the PDU set QoS parameter with the PSIHI value set to false or the separate information (e.g., the PDU set based handling allowance indicator) on whether to support the PDU set based handling, may determine the PDU set based service request without a separate reference PDU set QoS parameter for the PDU set based packet handling in the congestion situation, or the like. When the NG-RAN, which has received the PDU set QoS parameter with the PSIHI value set to false from the SMF, may request the PDU set based packet handling service to the SMF using the existing PDU set based handling indicator information. However, since the PCF or the SMF does not support the generation of the PDU set QoS parameter with the PSIHI value set to false, the NG-RAN, which has received the information (e.g., the PDU set based handling allowance indicator) on whether to support the PDU set based handling, may transfer PDU set based handling/marking request information to the SMF instead of the existing PDU set based handling indicator information.

According to an embodiment of the disclosure, the NG-RAN may perform a scheduling operation on specific packets based on PDU set Importance information, or the like, in the GTP-U extension header in the congestion situation. For the separate PDU set based service request, the NG-RAN may transfer the PDU set based handling request information (e.g., the PDU set based handling/marking request or the PDU set based handling indicator) to the SMF.

According to an embodiment of the disclosure, the SMF, which has received the PDU set based service request from the NG-RAN, may transfer, to the UPF, the N4 rule that may include the operation instruction information for generating the PDU set information and marking the generated PDU set information in the GTP-U extension header according to the configuration of the SMF and the related information, or the like. Based on the operation, each entity, RAN, or UE in the drawings may use the PDU set based service even when the separate PDU set QoS parameter information is not transferred from the AF. In addition, when the change in the NG-RAN occurs according to the movement of the UE, the PDU set based handling request information (e.g., the PDU set based handling/marking request or the PDU set based handling indicator) and/or separate information (e.g., the PDU set based handling allowance indicator) on whether to support the PDU set based handling received from the SMF may be included in the handover request message transferred from the source NG-RAN to the target NG-RAN or an AMF When the PDU set based handling or marking request is performed during a specific time when the congestion situation occurs, a timer or time-related information (e.g., the PDU set based handling/marking timer information) related to the specific time may be additionally included in the handover request message. By using the information, the UE may continue to use the PDU set based service without separate configuration or change even when the NG-RAN changes according to the movement of the UE.

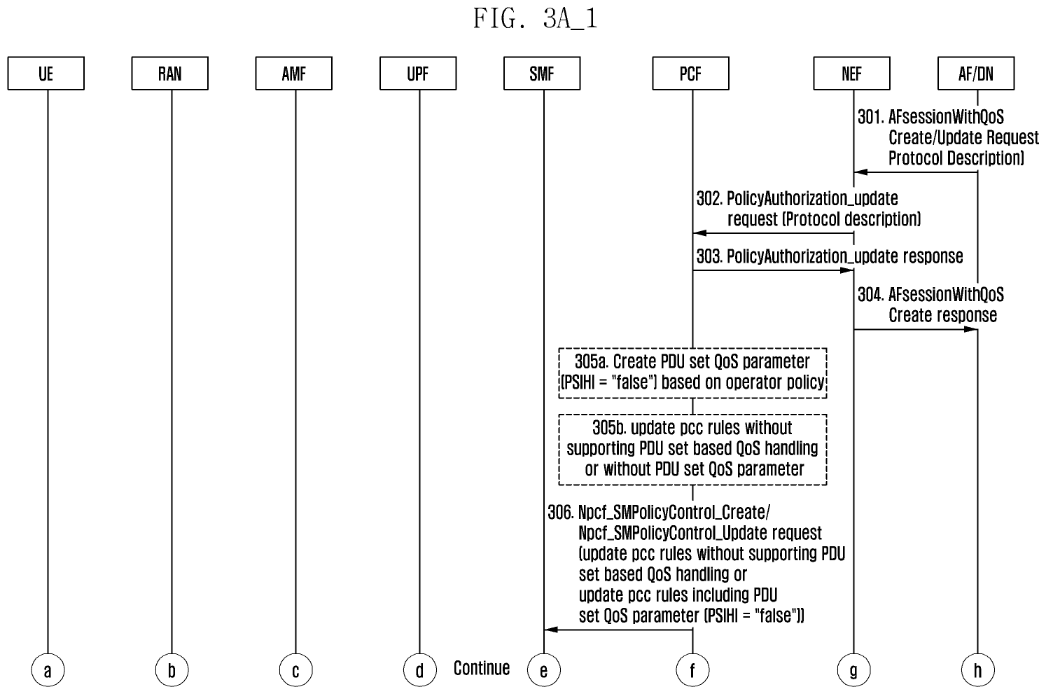

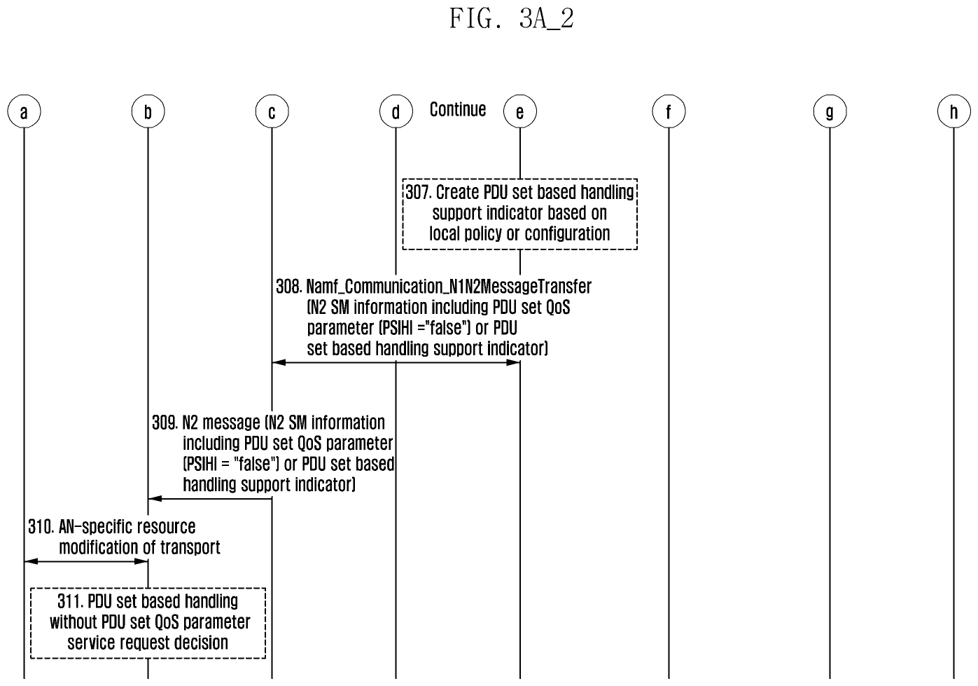

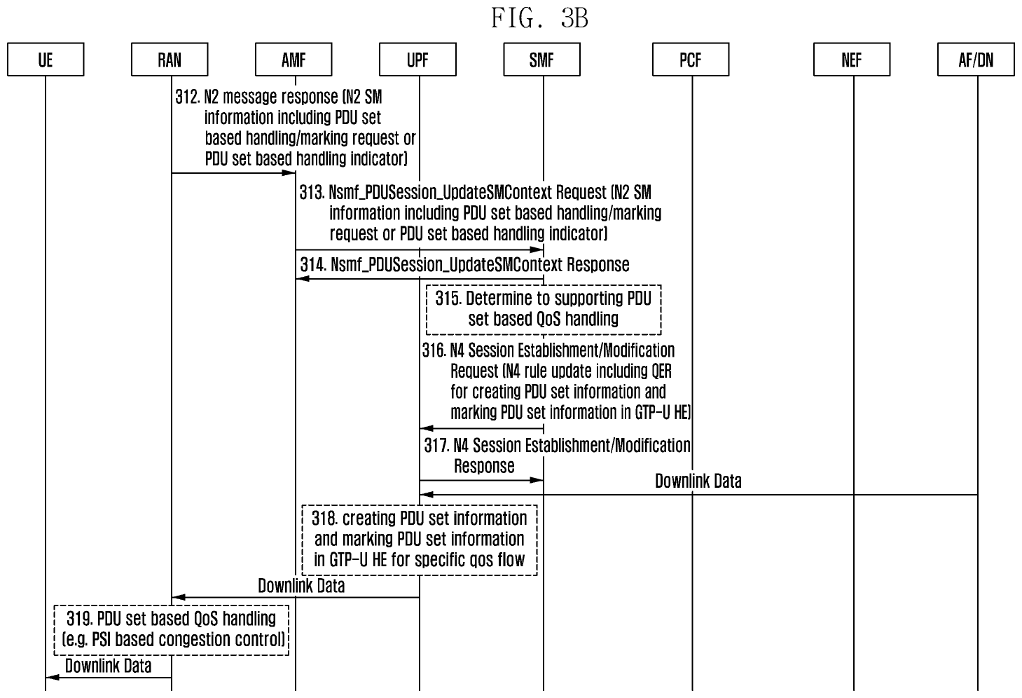

FIGS. 3A_1, 3A_2, and 3B illustrate requesting a service supporting PDU set based packet handling from an NG-RAN according to various embodiments of the disclosure.

Referring to FIGS. 3A_1, 3A_2, and 3B, according to an embodiment of the disclosure, a method performed by a session management function (SMF) entity in a wireless communication system may include receiving a PDU set QoS parameter including only PSIHI information with a PSIHI value set to false, information (e.g., PDU set based handling allowance indicator) on whether to support PDU set based handling, or the like, according to downlink packet-related characteristic information (protocol description) and/or a provider policy, or the like, from a PCF via PCC rule information; determining a PDU set based packet handling support based on the PCC rule information that includes the PDU set QoS parameter including only the PSIHI information with the PSIHI value set to false and/or the information (e.g., the PDU set based handling allowance indicator) on whether to support the PDU set based handling according to the downlink packet-related characteristic information (protocol description) and/or the provider policy, or the like, determining whether to generate the PDU set QoS parameter including only the PSIHI information with the PSIHI value set to false based on the PCC rule information including the information (e.g., the PDU set based handling allowance indicator) on whether to support the PDU set based handling according to the provider configuration, or the like, transferring, to NG-RAN, the PDU set QoS parameter including only the PSIHI information with the PSIHI value set to false or information (e.g., the PDU set based handling allowance indicator) that PDU set based packet handling is supported; receiving information (e.g., the PDU set based handling/marking request or the PDU set based handling indicator (when the PDU set QoS parameter including only the PSIHI information with the PSIHI value set to false is transferred from the SMF to the NG-RAN)) requesting PDU set based packet handling from NG-RAN; and generating the PDU set information based on the information requesting the PDU set based packet handling received from the NG-RAN and transferring an indicator and related information for performing a marking operation on the corresponding PDU set information in a GTP-U extension header to a UPF via an N4 rule.

In operation 301, the AF (or DN) may transfer a message (e.g., AFsessionWithQoS Create/Update request message) including the downlink packet-related characteristic information (protocol description) to the NEF in order to process the service data flow transferred from the AS via an appropriate QoS flow in the 5G system by considering the characteristics of the packet. In addition, according to an embodiment of the disclosure, the protocol description may be intended to transfer information (e.g., information, such as rtp or rtp over quic) on which protocol the corresponding packet includes. In addition, the header may be used to extract related information based on the protocol information and codec information, or in the case of the multiplexed data, provide information for distinguishing the multiplexed data on a packet-by-packet basis.

In operation 302, in order to process the service data flow transferred from the AS via the appropriate QoS flow in the 5G system by considering the characteristics of the packet, the downlink packet-related characteristic information (protocol description) and/or service QoS requirement information that includes the PDU set QoS parameter including only the PSIHI information with PSIHI value set to false according to the provider policy, or the like, may be authorized in the NEF, and thereafter, the downlink packet-related characteristic information (protocol description) and the service QoS requirement information transferred from the AF may be transferred to the PCF via a PolicyAuthorization create/update request message.

In operations 303 and 304, the PCF may transfer information on whether to accept or reject the request for QoS support considering the downlink packet-related characteristic information (protocol description) to the AF via a PolicyAuthorization_Create/update response message and an AFsessionWithQoS Create/update response message in order to process the service data flow transferred from the AS requested by the AF via the appropriate QoS flow in the 5G system by considering the characteristics of the packet. For example, the PCF may transfer the PolicyAuthorization_Create/update response message to the NEF, and the NEF may transfer the AFsessionWithQoS Create/update response message to the AF.

In operation 305a, the PCF, which has received only the downlink packet-related characteristic information (protocol description) from the AF, may not receive the PDU set QoS parameter, but may determine to support the PDU set based traffic handling without the separate PDU set QoS parameter according to the provider policy or configuration. Thereafter, the PCF may perform a PCC rule generation or update operation that includes the PDU set QoS parameter including only the PSIHI information with the PSIHI value set to false, and information (e.g., the PDU set based handling allowance indicator) on whether to support the PDU set based handling.

In operation 305b, the PCF may perform the PCC rule generation or update operation that includes service information for QoS support considering media characteristics of the service data flow based on the downlink packet-related characteristic information (protocol description) and the information (e.g., the PDU set based handling allowance indicator) on whether to support the PDU set based handling when the PCF related to operation 305a does not support the generation of the PDU set QoS parameter including only the PSIHI information with the PSIHI value set to false.

In operation 306, the PCF may transfer, to the SMF via a Npcf_SMPolicyControl_Create/Npcf_SMPolicyControl_Update message, the PCC rule (update pcc rules including PDU set based handling allowance indicator and/or the PDU set QoS parameter (PSIHI=“false”)) that includes the PDU set QoS parameter including only the PSIHI information with the PSIHI value set to false for support of PDU set based traffic handling without the separate PDU set QoS parameters according to service requirement information for QoS support considering the media characteristics of the service data flow based on the downlink packet-related characteristic information (protocol description) and/or the provider policy or configuration, and/or the information (e.g., PDU set based handling allowance indicator) on whether to support the PDU set based handling.

In operation 307, the SMF may determine the generation and support of the information (e.g., the PDU set QoS parameter including only the PSIHI information with the PSIHI value set to false or PDU set based handling allowance indicator) for supporting the PDU set based traffic handling according to the provider policy or configuration based on the PCC rule information received from the PCF. When the PCC rule received from the PCF includes the PDU set QoS parameter including only the PSIHI information with the PSIHI value set to false, operation 307 may be omitted. However, when the PCC rule received from the PCF includes only the information (e.g., PDU set based handling allowance indicator) on whether to support the PDU set based handling, the SMF may determine the generation of the PDU set QoS parameter including only the PSIHI information with the PSIHI value set to false or the separate PDU set based handling allowance indicator according to the provider policy or configuration.

In operation 308, when the SMF determines to support the PDU set based traffic handling according to the provider policy or configuration based on the PCC rule information received from the PCF, the SMF may transfer N2 SM information including at least one of the information (the PDU set QoS parameter including only the PSIHI information with the PSIHI value set to false or the separate PDU set based handling allowance indicator) generated in operation 307, QoS profile, or QFI(s), and/or N1 SM container including Qos rule to the AMF by including the N2 SM information and the NI SM container in the Namf_Communication_N1N2MessageTransfer message.

In operation 309, the AMF may transfer, to the NG-RAN via the N2 message, the N2 SM information including the information (for example, the PDU set QoS parameter (PSIHI=“false”) or PDU set based handling allowance indicator) on whether to support the PDU set based traffic handling without the PDU set QoS parameter received from the SMF. Alternatively, at least one piece of information or the N1 SM container included in the message received from the SMF in operation 308 may be transmitted to the NG-RAN.

In operation 310, when the NG-RAN receives the N1 SM container including the Qos rule from the SMF, the NG-RAN may transfer the N1 SM container to the UE.

In operation 311, the NG-RAN may determine whether to request a service for the PDU set based traffic handling based on the information (e.g., the PDU set QoS parameter (PSIHI=“false”) or the PDU set based handling allowance indicator) on whether to support the PDU set based traffic handling without the PDU set QoS parameter received from the SMF.

In operation 312, when the NG-RAN determines a service request for the PDU set based traffic handling without the separate PDU set QoS parameter in operation 311, the NG-RAN may transfer the N2 SM information including the service request information (e.g., the PDU set based handling/marking request or the PDU set based handling indicator) for the PDU set based traffic handling without the separate PDU set QoS parameter to the AMF via an N2 message response.

In operation 313, the AMF may transfer the N2 SM information including the service request information (e.g., the PDU set based handling/marking request or the PDU set based handling indicator) for the PDU set based traffic handling without the separate PDU set QoS parameter received from the NG-RAN to the SMF via a request message (e.g., Nsmf_PDUSession_UpdateSMContext). In operation 314, the SMF may transfer a response message to the request message received from the AMF to the AMF.

In operation 315, the SMF may perform the N4 rule generation or update operation to support the PDU set based traffic handling without the separate PDU set QoS parameter, including a forward action rule (FAR) for QoS mapping of the corresponding service data flow based on the service request information (e.g., the PDU set based handling/marking request or the PDU set based handling indicator) for the PDU set based traffic handling received from the NG-RAN, a QoS flow identifier (QFI) received from the PCF, and/or protocol description information, a QoS enforcement rule (QER) including information instructing an operation to generate the PDU set information for the PDU set based traffic handling and an operation to mark the generated PDU set information in the GTP-U extension header, a packet detection rule (PDR) including characteristic information (protocol description) of a packet to be used when generating the PDU set information.

In operations 316 and 317, the SMF may transfer, to the UPF, an SDF template or message including information, or the like, on a packet detection operation within a service flow to support the PDU set based traffic handling without the separate PDU set QoS parameter via an N4 session establishment/modification process (e.g., an N4 session establishment/modification request message), an operation of mapping packets detected for each media type or each synchronization source identifier (SSRC) to a QoS flow, an operation of marking the PDU set information within real-time transport protocol (RTP) header extension (HE) to a general packet radio service (GPRS) tunneling protocol user plane (GTP-U) header extension (HE), and an operation of generating the PDU set information based on the protocol description information. In addition, according to an embodiment of the disclosure, information on the N4 rule related to the information may be transmitted. The UPF may transmit a response message (e.g., an N4 session establishment/modification response message) to the SMF.

In operation 318, the UPF may receive the N4 rule including requirements for supporting the PDU set based traffic handling without the separate PDU set QoS parameter from the SMF, and then perform appropriate PDU set information generation based on the characteristic information of packets of the corresponding service data flow. In addition, the operation of marking the generated PDU set information in the GTP-U extension header may be performed. In order to support the PDU set based traffic handling without the separate PDU set QoS parameter, the PDU set information generated by the UPF may include at least one PDU set importance information. For example, the UPF may perform distinguish of information (e.g., media type information, or SSRC information in a header of a packet, and a payload type or an RTP-M field) of packets in the service data flow transferred from the AS using the protocol description, and may allocate an appropriate PDU set importance value based on the information in the protocol description when generating the PDU set importance.

In addition, the PDU set importance value information considering the media characteristics may be included separately in the protocol description or determined according to the provider policy or configuration. For example, a video service data flow includes an I/B/P frames may be configured such that the I frame is assigned the lowest PDU set importance value based on the importance of the frame.

According to an embodiment of the disclosure, the NG-RAN may receive PDU set information or downlink data generated by the UPF.

In operation 319, the NG-RAN may perform an RAN scheduling operation based on the PDU set information generated by the UPF when the congestion situation occurs. For example, a control operation for the congestion situation may be performed by an operation of preferentially dropping packets with a high PSI value based on the PDU set importance (PSI) information of the packets transferred via the GTP-U extension header. When the NG-RAN temporarily requests the PDU set based traffic handling without the separate PDU set QoS parameter when the congestion situation occurs, the NG-RAN may additionally transfer information (e.g., the PDU set based handling/marking timer) requesting the SMF to perform the generation and marking operation of the PDU set information for a certain period to the SMF. Based on the corresponding timer information, the SMF may perform the N4 rule generation or update operation including an instruction for the PDU set information generation and marking operation to support the PDU set based traffic handling without the separate PDU set QoS parameter for a certain period in the UPF.

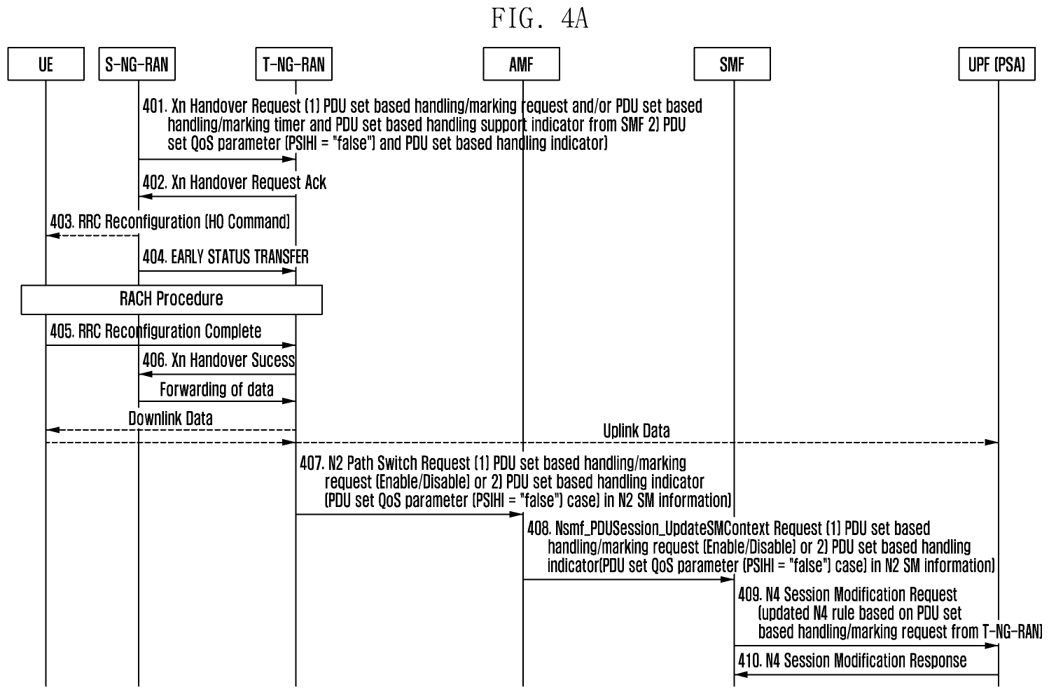

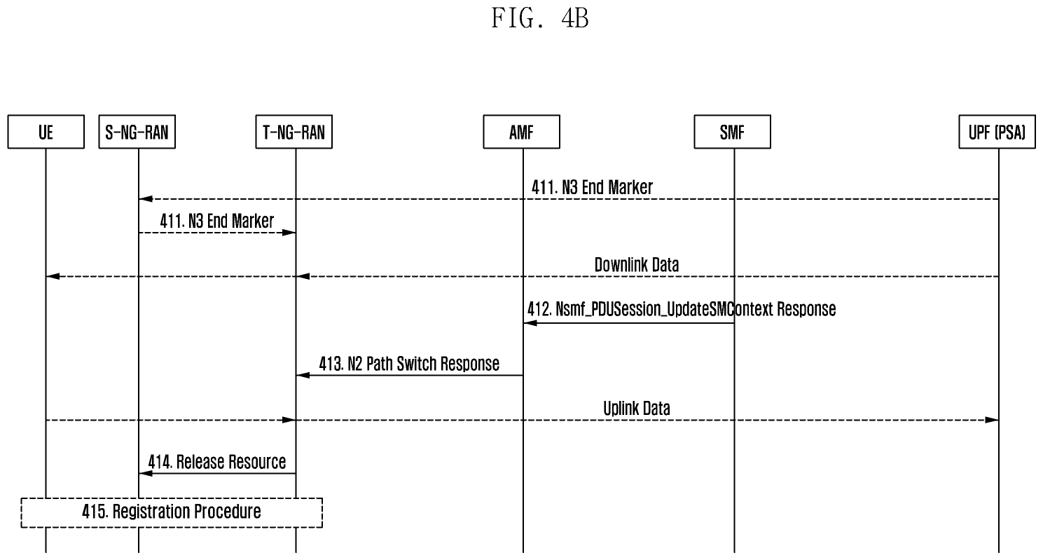

FIGS. 4A and 4B illustrate supporting an Xn handover operation according to a movement of a UE when using a service supporting a PDU set based packet handling according to various embodiments of the disclosure.

Referring to FIGS. 4A and 4B, a source NG-RAN, which uses a service supporting the PDU set based packet handling in the source NG-RAN or receives the PDU set based packet handling service support information from the SMF, transfers related information to a target NG-RAN when performing a handover operation, so the source NG-RAN may use the service supporting the PDU set based packet handling even after the handover operation according to the movement of the UE or may request a service newly supporting the PDU set based packet handling according to the situation of the target NG-RAN.

In operation 401, the source NG-RAN may transfer whether to use the service supporting the PDU set based packet handling in the source NG-RAN and related information (e.g., the PDU set based handling/marking request and/or the PDU set based handling/marking timer) and the PDU set based packet handling service support information (e.g., the PDU set based handling allowance indicator or the PDU set QoS parameter (PSIHI=“false”)) received from the SMF to the target NG-RAN using an Xn handover request message.

According to an embodiment of the disclosure, when the PCF or the SMF generates or receives, from the PCF, the information (e.g., the PDU set QoS parameter including only PSIHI value with PSIHI value set to “false”) on whether to support the PDU set based packet handling service according to the provider policy, the SMF may transfer the information on whether to support the PDU set based packet handling service to the NG-RAN in the 5GC using the PDU set QoS parameter including only the PSIHI value where the PSIHI value is set to “false” and the information (e.g., the PDU set based handling allowance indicator) on whether to support the PDU set based handling.

According to an embodiment of the disclosure, the source NG-RAN, which has received the PDU set QoS parameter including only the PSIHI value where the PSIHI value is set to “false” from the SMF, may transfer the corresponding PDU set QoS parameter to the target NG-RAN. In the case, the source NG-RAN may transfer the information on whether to use the PDU set based packet handling service in the corresponding source NG-RAN to the target NG-RAN by transferring the PDU set based handling indicator to the target NG-RAN instead of the PDU set based handling/marking request.

In operation 402, the target NG-RAN may determine whether to accept a handover of a target NG-RAN node and then transmit a HANDOVER REQUEST ACKNOWLEDGE message to a source RAN node. The message may include information for a conditional handover.

In operation 403, the source NG-RAN may transmit an RRC reconfiguration message to the UE, and the message may include information related to the handover (e.g., a handover (HO) command).

In operation 404, for a data radio bearer (DRB) including DAPS, the source NG-RAN may transmit an EARLY STATUS TRANSFER to the target NG-RAN.

According to an embodiment of the disclosure, the UE may perform a RACH procedure to a base station (e.g., target NG-RAN).

In operation 405, the target NG-RAN may receive an RRC reconfiguration complete message from the UE to complete the handover (or the conditional handover) configuration.

In operation 406, the target NG-RAN may transfer an Xn handover success message to the source NG-RAN to notify that a preparation phase for performing the handover is complete.

In operation 407, the target NG-RAN may transfer the N2 SM information including at least one of the PDU set based packet handling service request information (e.g., the PDU set based handling/marking request or the PDU set based handling indicator), AN tunnel Info, or the like, to the AMF via an N2 path switch request message.

In operation 408, the AMF may transfer the N2 SM information including at least one of the PDU set based packet handling service request information (e.g., the PDU set based handling/marking request or the PDU set based handling indicator), the AN tunnel Info, or the like, received from the target NG-RAN to the SMF.

In operation 409, when there is no separate PDU set based packet handling service request information (e.g., the PDU set based handling/marking request or the PDU set based handling indicator) in the N2 SM information received from the target NG-RAN (via the AMF), the SMF may perform an N4 rule update to stop the corresponding operation when there is the PDU set information generation and marking operation in the N4 rule currently transferred from the UPF.

In operation 409, based on the information received from the target NG-RAN, the AN tunnel Info, or the like, may be updated, or the N4 rule including the execution of the PDU set information generation and marking operation or the stop operation may be transferred to the UPF via an N4 session modification request message.

In operation 410, a response message to N4 rule transfer including updating the AN tunnel Info requested to be transferred to the UPF or performing the PDU set information generation and marking operation or the stop operation may be transferred to the SMF using an N4 session modification response. The message may include CN tunnel Info.

In operation 411, the UPF may transmit one or more “N3 end marker” packets to the source NG-RAN via an old path for each N3 tunnel immediately after path switching to support a reordering function in the target NG-RAN. The source NG-RAN may transfer the “N3 end marker” to the target NG-RAN. Thereafter, the UPF may start downlink packet transmission to the target NG-RAN.

In operation 412, the SMF may transfer the N2 SM information including the UPF-related CN tunnel Info to the AMF via an Nsmf_PDUSession_UpdateSMContext response message.

In operation 413, when the AMF receives an Nsmf_PDUSession_UpdateSMContext response from all/some of the SMFs, the AMF may transmit the N2 SM information including at least one collected CN tunnel Info received from the SMFs together with failed PDU sessions information to the target NG-RAN using an N2 path switch request Ack message (or N2 path switch response message).

In operation 414, the target NG-RAN may transmit a release resources message to the source NG-RAN so that the target NG-RAN may transfer information on whether the handover was successful. Based on the message, the source NG-RAN may trigger a resource release.

In operation 415, the UE may initiate a mobility registration update procedure when one of the triggers of the registration procedure is satisfied.

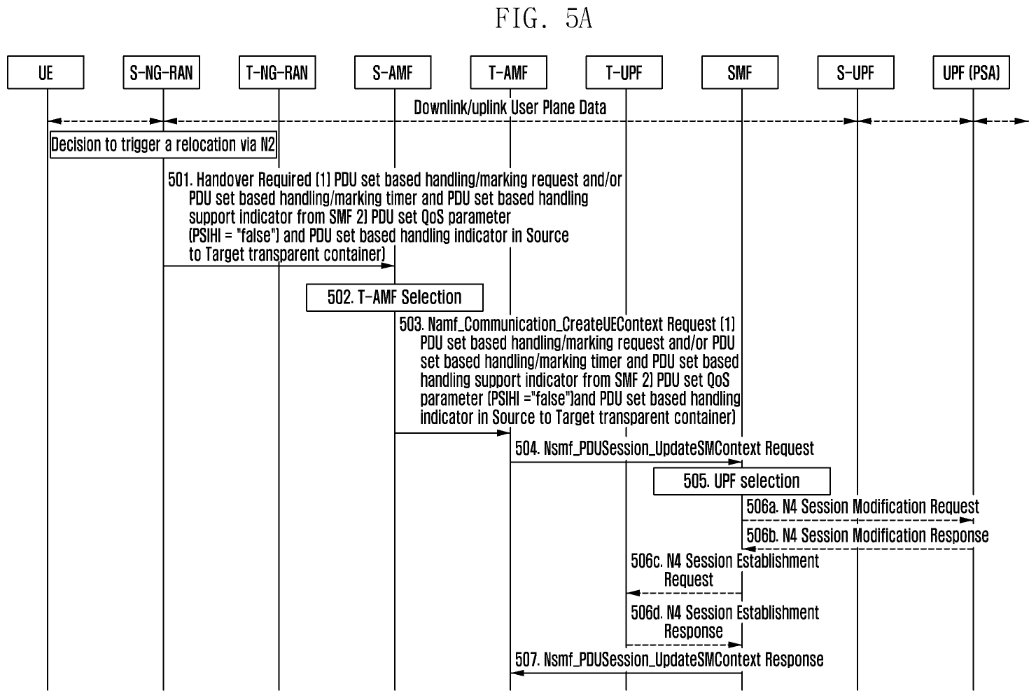

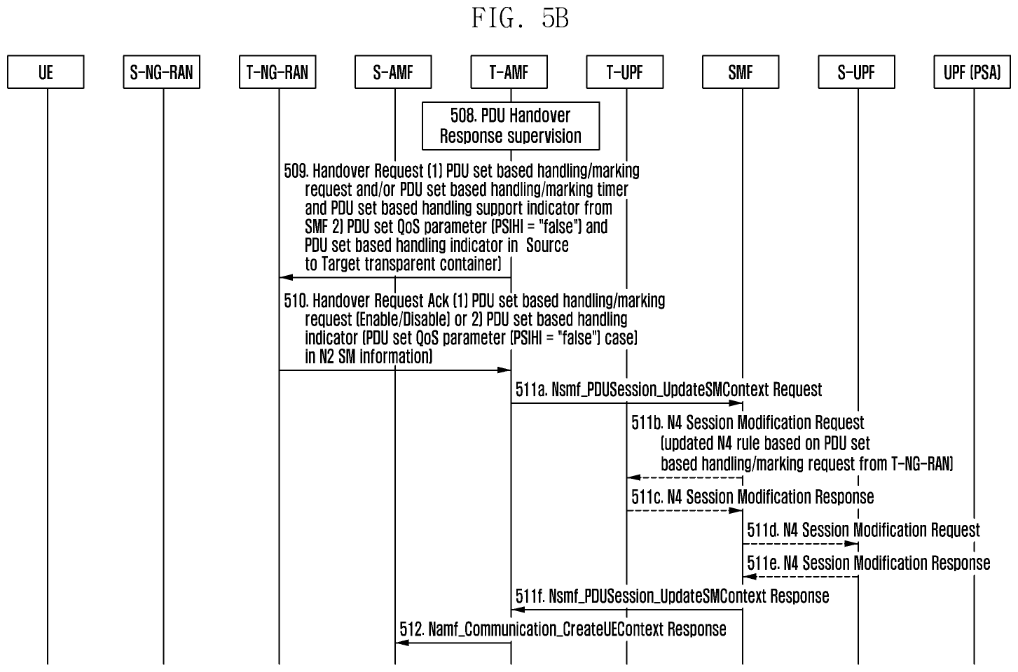

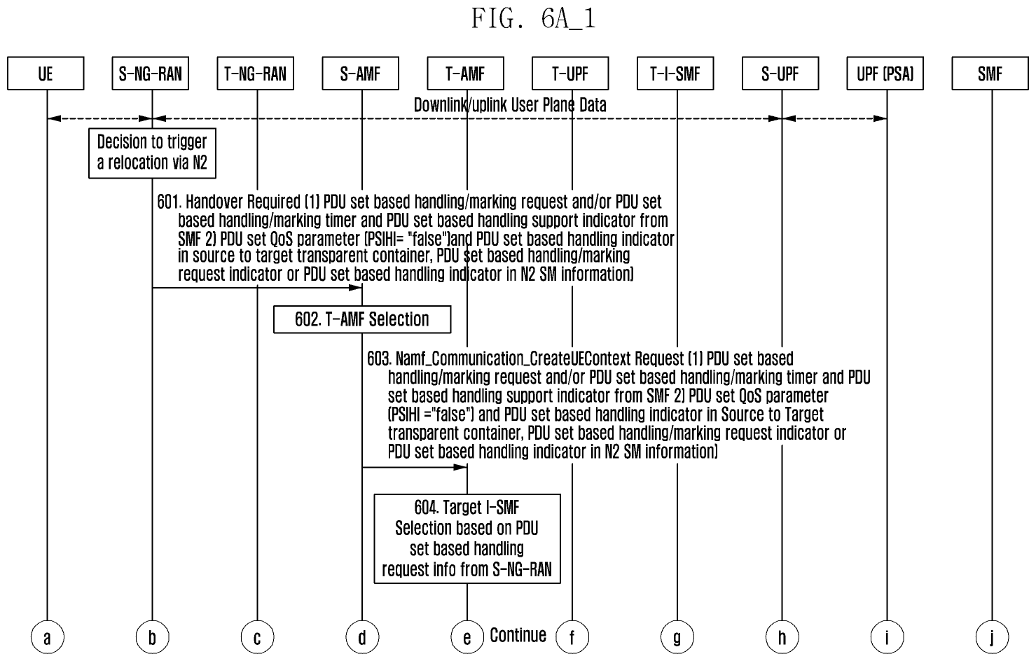

FIGS. 5A and 5B illustrate examples of supporting an N2 handover operation according to the movement of the UE when using the service supporting the PDU set based packet handling according to various embodiments of the disclosure.

In operation 501, the source NG-RAN may transfer, to the source AMF via the handover request message, a source to target transparent container that includes whether to use the service supporting the PDU set based packet handling in the source NG-RAN and the related information (e.g., the PDU set based handling/marking request and/or the PDU set based handling/marking timer or the PDU set based handling indicator) and the PDU set based packet handling service support information (e.g., the PDU set based handling allowance indicator or the PDU set QoS parameter (PSIHI=“false”)) received from the SMF.

According to an embodiment of the disclosure, when the PCF or the SMF generates or receives the information (e.g., the PDU set QoS parameter including only the PSIHI value where the PSIHI value is set to “false”) on whether to support the PDU set based packet handling service according to the provider policy, the SMF may transfer the information on whether to support the PDU set based packet handling service to the NG-RAN in the 5GC using the PDU set QoS parameter including only the PSIHI value where the PSIHI value is set to “false”.

According to an embodiment of the disclosure, when the PCF or the SMF generates or receives the information (e.g., the PDU set QoS parameter including only the PSIHI value where the PSIHI value is set to “false”) on whether to support the PDU set based packet handling service without the PDU set QoS parameter information according to the provider policy, the SMF may transfer the information on whether to support the PDU set based packet handling service without the PDU set QoS parameter information in the 5GC to the NG-RAN using the PDU set QoS parameter including only the PSIHI value where the PSIHI value is set to “false”.

According to an embodiment of the disclosure, the source NG-RAN, which has received the PDU set QoS parameter including only the PSIHI value where the PSIHI value is set to “false” from the SMF, may transfer the corresponding PDU set QoS parameter to the target NG-RAN. In this case, the source NG-RAN may transfer the PDU set based handling indicator to the target NG-RAN instead of the PDU set based handling/marking request, and transfer the information on whether to use the PDU set based packet handling service from the source NG-RAN to the target NG-RAN via the S-AMF by including the information in the source to target transparent container.

In operation 502, an S-AMF may perform a selection operation of a T-AMF when the UE moves to another PLMN or moves to a service area not supported by the S-AMF.

In operation 503, the S-AMF selects the T-AMP, and then transfers, to the T-AMF via a Namf_Communication_CreateUEContext request message, the source to target transparent container that includes whether to use the service supporting the PDU set based packet handling received from the source NG-RAN and related information (e.g., the PDU set based handling/marking request and/or the PDU set based handling/marking timer or the PDU set based handling indicator) and the PDU set based packet handling service support information (e.g., the PDU set based handling allowance indicator or the PDU set QoS parameter (PSIHI=“false”)) received from the SMF, and/or handover related information.

In operation 504, the T-AMF may transfer, to the SMF via an Nsmf_PDUSession_UpdateSMContext message, the related information for performing the handover, such as the PDU session ID, target ID, T-AMF ID, and N2 SM information, which do not include separate PDU set related information, when whether to use the service supporting the PDU set-based packet handling and the related information, and the PDU set based packet handling service support information received from the SMF is directly transferred to the target NG-RAN via the source to target transparent container.

In operation 505, the SMF may identify whether the target ID is within a service area of the UPF connected to the NG-RAN. When the UE leaves the service area of the UPF connected to the NG-RAN, the SMF may select a new intermediate UPF (T-UPF).

In operation 506a, the SMF selects a new UPF (T-UPF) to perform the role of the intermediate UPF of the PDU session, and when another CN tunnel Info is used, may transmit the N4 session modification request message including the CN tunnel Info related to N9 to the UPF (PSA).

In operation 506b, the UPF (PSA) may transfer the N4 session modification response message including the CN tunnel Info (on N9) information of the UPF (PSA) to the SMF.

In operation 506c, the SMF selects a new intermediate UPF as the target UPF (T-UPF) for the PDU session in operation 505, and then, when the CN tunnel Info for the T-UPF is allocated, may transmit an N4 session establishment request message to the T-UPF to provide at least one of packet detection, enforcement, or reporting rule to the T-UPF. The CN tunnel Info (N9) of the UPF (PSA) used to configure an N9 tunnel may also be provided to the T-UPF.

In operation 506d, the T-UPF may transfer DL CN tunnel Info and UL CN tunnel Info (e.g., N3 tunnel information) to the SMF via an N4 session establishment response message.

In operation 507, the SMF may transfer, to the T-AMF, the Nsmf_PDUSession_UpdateSMContext response message that includes at least one of the N2 SM information including an N3 UP address of the UPF and a UL CN tunnel ID, a QoS parameter, time sensitive communication assistance information (TSCAI), or user plane security enforcement information for the target NG-RAN.

In operation 508, the T-AMF may receive the Nsmf_PDUSession_UpdateSMContext response message from the related SMFs, and when a maximum waiting time expires or all the Nsmf_PDUSession_UpdateSMContext response message have been received, the T-AMF may continue to perform an N2 handover procedure.

In operation 509, the T-AMF transfers, to the target NG-RAN, the handover request message including the source to target transparent container that includes whether to use the service supporting the PDU set based packet handling received from the source NG-RAN and related information (e.g., the PDU set based handling/marking request and/or the PDU set based handling/marking timer or the PDU set based handling indicator) and the PDU set based packet handling service support information (e.g., the PDU set based handling allowance indicator or the PDU set QoS parameter (PSIHI=“false”)) received from the SMF.

According to an embodiment of the disclosure, the target NG-RAN may determine the PDU set based packet handling service request according to the information in the source to target transparent container and/or the policy or situation of the target NG-RAN.

In operation 510, the target NG-RAN may transfer the information (e.g., the N2 SM information) including request information (e.g., the PDU set based handling/marking request or the PDU set based handling indicator) (e.g., the PDU set based packet handling service request information) of the service supporting the PDU set based packet handling to the T-AMF via a handover request Ack message.

In operation 511a, the T-AMF may transfer the information (e.g., the N2 SM information) including at least one of the PDU set based packet handling service request information (e.g., the PDU set based handling/marking request or the PDU set based handling indicator), the AN tunnel Info, or the like, received from the target NG-RAN to the SMF.

In operations 511b to 511e, when there is no separate PDU set based packet handling service request information (e.g., the PDU set based handling/marking request or the PDU set based handling indicator) in the N2 SM information received from the target NG-RAN, the SMF may perform an additional operation based on whether the PDU set information generation and marking operations are present in the N4 rules transferred from the current UPF. When the existing N4 rule transferred in the UPF includes the PDU set information generation and marking operation, the N4 rule update may be performed to stop the corresponding operation. For example, the SMF may transmit the N4 session modification request message to the T-UPF or the S-UPF for the N4 rule update, and may receive the N4 session modification response message from the T-UPF or the S-UPF in response thereto. However, when the PDU set information generation and marking operation is not included in the existing N4 rule transferred in the UPF, but the separate PDU set based packet handling service request information (e.g., the PDU set based handling/marking request or the PDU set based handling indicator) is transferred in the N2 SM information received from the target NG-RAN, the N4 rule update including the PDU set information generation and marking operation may be performed and the related information may be transferred to the T-UPF or the S-UPF.

According to an embodiment of the disclosure, when the N2 SM information received from the target NG-RAN does not include the separate PDU set based packet handling service request information and does not include the PDU set information generation and marking operation in the existing N4 rule, or when the N2 SM information received from the target NG-RAN includes the separate PDU set based packet handling service request information and includes the PDU set information generation and marking operation in the existing N4 rule, the N4 rule update and the transfer process to the T-UPF or S-UPF may be omitted.

In operation 511f, the SMF may generate information (e.g., the N2 SM information) including DL forwarding tunnel Info to be transmitted from the T-AMF to the S-AMF. According to an embodiment of the disclosure, when direct forwarding is applied, the SMF may transfer T-RAN N3 forwarding information received in operation 11a to the T-AMF via the Nsmf_PDUSession_UpdateSMContext response message. Additionally, according to an embodiment of the disclosure, when an indirect forwarding tunnel is configured in operation 11b or 11d, the SMF may transmit, to the T-AMF, at least one of T-UPF or S-UPF DL forwarding information including the N3 UP address and a DL tunnel ID of the UPF by including at least one of the T-UPF or S-UPF DL forwarding information in the Nsmf_PDUSession_UpdateSMContext response message.

In operation 512, after the T-AMF receives the Nsmf_PDUSession_UpdateSMContext response message from the related SMFs, the T-AMF may transmit the Namf_Communication_CreateUEContext response to the S-AMF when the maximum waiting time expires or the T-AMF receives the Nsmf_PDUSession_UpdateSMContext response message from all the SMFs.

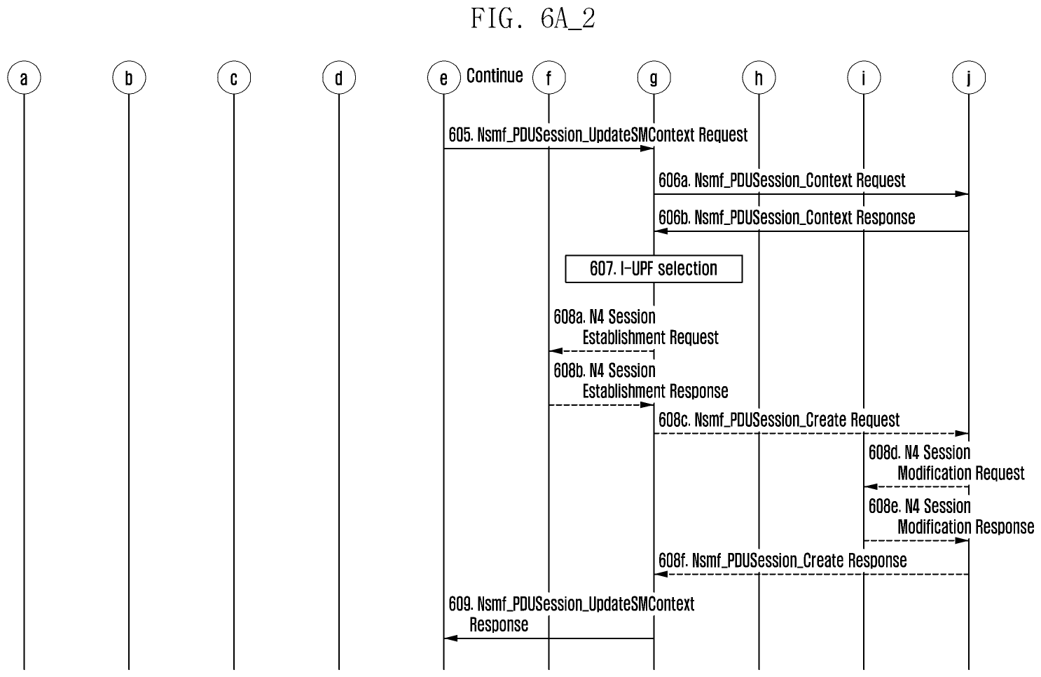

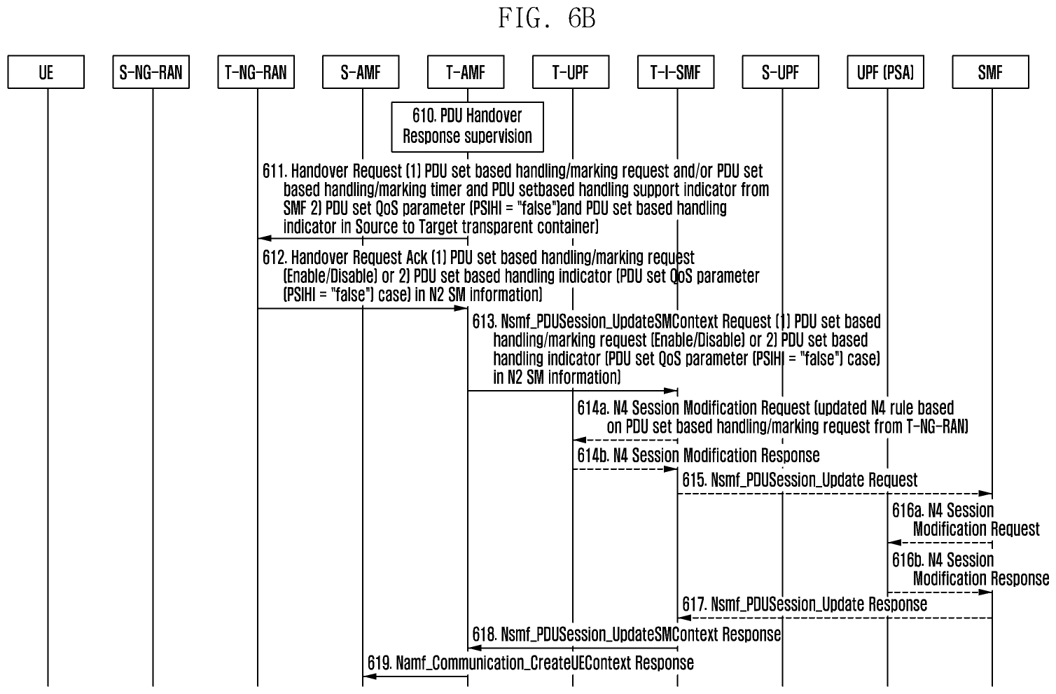

FIGS. 6A_1, 6A_2, and 6B illustrate supporting a N2 handover operation to which I-SMF selection and insertion operations are added according to the movement of the UE when using a service supporting a PDU set based packet handling according to various embodiments of the disclosure.

Referring to FIGS. 6A_1, 6A_2, and 6B, in operation 601, the source NG-RAN may transfer, to the source AMF via the handover request message, a source to target transparent container that includes whether to use the service supporting the PDU set based packet handling in the source NG-RAN and the related information (e.g., the PDU set based handling/marking request and/or the PDU set based handling/marking timer or the PDU set based handling indicator) and the PDU set based packet handling service support information (e.g., the PDU set based handling allowance indicator or the PDU set QoS parameter (PSIHI=“false”)) received from the SMF.

According to an embodiment of the disclosure, when the PCF or the SMF generates or receives the information (e.g., the PDU set QoS parameter including only the PSIHI value where the PSIHI value is set to “false”) on whether to support the PDU set based packet handling service according to the provider policy, the SMF may transfer the information on whether to support the PDU set based packet handling service to the NG-RAN in the 5GC using the PDU set QoS parameter including only the PSIHI value where the PSIHI value is set to “false”.

According to an embodiment of the disclosure, the source NG-RAN, which has received the PDU set QoS parameter including only the PSIHI value where the PSIHI value is set to “false” from the SMF, may transfer the corresponding PDU set QoS parameter to the target NG-RAN. In this case, the source NG-RAN may transfer the PDU set based handling indicator to the target NG-RAN instead of the PDU set based handling/marking request, and transfer the information on whether to use the PDU set based packet handling service from the source NG-RAN to the target NG-RAN via the S-AMF by including the information in the source to target transparent container.

According to an embodiment of the disclosure, in the case of the N2 handover, the target SMF (I-SMF) may be separately configured according to an inter PLMN handover or the location of the UE, so the service information (e.g., the PDU set based handling/marking request indicator or the PDU set based handling indicator) being used by the source NG-RAN and/or the information (e.g., PDU set based handling allowance indicator or the PDU set QoS parameter (PSIHI=“false”)) received from the SMF may be separately transferred to the S-AMF via the N2 SM information without being included in the source to target transparent container from the source NG-RAN. The source NG-RAN may transfer the information on whether the PDU set based handling service is requested to the S-AMF and/or the target NG-RAN via the separate PDU set based handling/marking request indicator or the PDU set based handling indicator information.

In operation 602, the S-AMF may perform the selection operation of the T-AMF when the UE moves to another PLMN or moves to the service area not supported by the S-AMF.

In operation 603, the S-AMF selects the T-AMP, and then transfers, to the T-AMF via the Namf_Communication_CreateUEContext request message, the source to target transparent container that includes whether to use the service supporting the PDU set based packet handling received from the source NG-RAN and related information (e.g., the PDU set based handling/marking request and/or the PDU set based handling/marking timer or the PDU set based handling indicator) and the PDU set based packet handling service support information (e.g., the PDU set based handling allowance indicator or the PDU set QoS parameter (PSIHI=“false”)) received from the SMF, and/or the handover related information.

According to an embodiment of the disclosure, in the case of the N2 handover, the target SMF (I-SMF) may be separately configured according to the inter PLMN handover or the location of the UE, so the service information (e.g., the PDU set based handling/marking request indicator or the PDU set based handling indicator) being used by the source NG-RAN and/or the information (e.g., PDU set based handling allowance indicator or the PDU set QoS parameter (PSIHI=“false”)) received from the SMF may be additionally transferred to the T-AMF via the Namf_Communication_CreateUEContext request message without being included in the source to target transparent container from the source NG-RAN.

In operation 604, the target AMF may determine whether it is necessary to select (new) target I-SMF according to a target UE location and/or a service area of the SMF for PDU session in UE context.

According to an embodiment of the disclosure, when selecting the target I-SMF from the target AMF, the information received from the related source NG-RAN may be utilized to select the target I-SMF that may support the PDU set based packet handling in an environment where the PDU set QoS parameter is not provided, based on the service (e.g., the PDU set based handling/marking request indicator or the PDU set based handling indicator) being used by the source NG-RAN and/or the information (e.g., the PDU set based handling allowance indicator or the PDU set QoS parameter (PSIHI=“false”)) received from the SMF. For example, in order to select the target I-SMF from the target AMF, information, such as the PDU set based handling/marking request indication or PDU set based handling indicator w/o PDU set QoS parameter indication may be included in NF profile information transferred to the NRF.

In operation 605, the T-AMF may transfer, to the target SMF (I-SMF) via an Nsmf_PDUSession_UpdateSMContext message, the related information for performing handover, such as PDU session ID, target ID, T-AMF ID, and N2 SM information, which do not include the separate PDU set related information, when whether to use the service supporting the PDU set based packet handling and the related information, and the PDU set based packet handling service support information received from the SMF are directly transferred to the target NG-RAN via the source to target transparent container.

In operation 606a, the target SMF (I-SMF) may transfer the Nsmf_PDUSession_Context request message including an SM context type and/or an SM context ID to the SMF in order to receive an SM context from the SMF.

In operation 606b, the SMF may transfer the SM context requested by the target SMF to the target SMF via the Nsmf_PDUSession_Context response message.

In operation 607, the target SMF may select an appropriate target I-UPF based on the SM context information (e.g., S-NSSAI and/or UE location information, or the like) received from the SMF.

In operation 608a, the target SMF may transmit an N4 session establishment request message and provide at least one of the packet detection, enforcement, or reporting rules to the T-UPF. The CN tunnel Info (N9) of the UPF (PSA) used to configure the N9 tunnel may also be provided to the T-UPF.

In operation 608b, the T-UPF may transfer the N4 session establishment response message including the DL CN tunnel Info (e.g., the N9 tunnel info) and the UL CN tunnel Info (e.g., the N3 tunnel info) of the T-UPF to the SMF.

In operation 608c, the target SMF may transfer an Nsmf_PDUSession_Create request message including at least one of the PDU session ID, HO preparation indication, or the like, to the SMF.

In operation 608d, the SMF may transfer the N4 session modification request message to the UPF (PSA) to request the related CN tunnel information from the UPF (PSA) when the PSA UPF uses different information from the N3 and N9-related CN tunnel Info.

In operation 608e, the UPF (PSA) may transfer the N4 session modification response message including the CN tunnel Info (on N9) to the SMF.

In operation 608f, the SMF may transfer the Nsmf_PDUSession_Create response message including at least one of the PDU session ID or the CN tunnel Info of the UPF (PSA) for N9 to the target SMF.

According to an embodiment of the disclosure, the target SMF may transfer the received UPF (PSA)-related CN tunnel Info (on N9) to the target UPF via an N4 session modification message.

In operation 609, the target SMF may transfer the Nsmf_PDUSession_UpdateSMContext response message that includes the N2 SM information including the N3 UP address of the target UPF and the UL CN tunnel ID, and the QoS parameter to the T-AMF.

In operation 610, the T-AMF may receive the Nsmf_PDUSession_UpdateSMContext response message including the information on whether to accept the N2 handover of the PDU session as in operation 609 from the related target SMFs, and when the maximum waiting time expires or the Nsmf_PDUSession_UpdateSMContext response message is received from all the target SMFs, the T-AMF may continue to perform the N2 handover procedure.

In operation 611, the T-AMF transfers, to the target NG-RAN, the handover request message including the source to target transparent container that includes whether to use the service supporting the PDU set based packet handling received from the source NG-RAN and the related information (e.g., the PDU set based handling/marking request and/or the PDU set based handling/marking timer or the PDU set based handling indicator) and the PDU set based packet handling service support information (e.g., the PDU set based handling allowance indicator or the PDU set QoS parameter (PSIHI=“false”)) received from the SMF.

According to an embodiment of the disclosure, the target NG-RAN may determine the PDU set based packet handling service request according to the information in the source to target transparent container and/or the policy or situation of the target NG-RAN.

In operation 612, the target NG-RAN may transfer the information (e.g., the N2 SM information) including request information (e.g., the PDU set based handling/marking request or the PDU set based handling indicator) of the service supporting the PDU set based packet handling to the T-AMF via a handover request Ack message.

In operation 613, the T-AMF may transfer the information (e.g., the N2 SM information) including at least one of the PDU set based packet handling service request information (e.g., the PDU set based handling/marking request or the PDU set based handling indicator) (e.g., the PDU set based packet handling service request information), the AN tunnel Info, or the like, received from the target NG-RAN to the target SMF.

From operations 614a to 614b, in the case where there is the separate PDU set based packet handling service request information (e.g., the PDU set based handling/marking request or the PDU set based handling indicator) in the N2 SM information received from the target NG-RAN, when the target SMF may determine to perform the PDU set information generation and marking operation in the target I-UPF according to the provider policy or configuration, the target SMF may perform the N4 rule update and transfer the N4 rule update to the target I-UPF via the N4 session modification message. Thereafter, in operation 615, the target SMF may transfer information requesting to stop the PDU set information generation and marking operation in the UPF (PSA) to the SMF via the Nsmf_PDUSession_Create request message.

In operations 616a and 616b, the SMF may perform the updated N4 rule update operation including the changed QER including the operation stop information to stop the PDU set information generation and the corresponding PSI (the PDU set information) information marking operation in the GTP-U confirmation header field that are operating in the UPF (PSA). Thereafter, the SMF may transfer the updated N4 rule including the changed QER to the UPF (PSA) via an N4 session modification message.

According to an embodiment of the disclosure, when there is no separate PDU set based packet handling service request information (e.g., the PDU set based handling/marking request or the PDU set based handling indicator) in the N2 SM information received from the target NG-RAN in operation 613, the target SMF may omit operations 614a and 614b. Thereafter, the target SMF may transfer the separate PDU set based packet handling service request information including the PDU set based handling/marking request (disable) information received from the target NG-RAN to the SMF via the Nsmf_PDUSession_Create request message.

According to an embodiment of the disclosure, when there is the PDU set information generation and marking operation in the N4 rule preset in the PSA (the UPF), the SMF may perform the N4 rule update to stop the PDU set information generation and marking operation. Thereafter, the SMF may transfer the updated N4 rule including the changed QER to the UPF (PSA) via the N4 session modification message to request the stop of the PDU set information generation and marking operation.

In operation 617, the SMF may transfer PDU session update result information to the T-SMF based on the separate PDU set based packet handling service request information (e.g., the PDU set based handling/marking request or the PDU set based handling indicator) in the N2 SM information received from the target NG-RAN.

In operation 618, the target SMF may transfer, to the T-AMF, the Nsmf_PDUSession_UpdateSMContext response message that includes the PDU session update result information received from the SMF or the PDU session update result information within the target SMF, or the like.

In operation 619, after the T-AMF receives the Nsmf_PDUSession_UpdateSMContext response message from the related SMFs, the T-AMF may transmit the Namf_Communication_CreateUEContext response to the S-AMF when the maximum waiting time expires or the T-AMF receives the Nsmf_PDUSession_UpdateSMContext response message from all the SMFs.

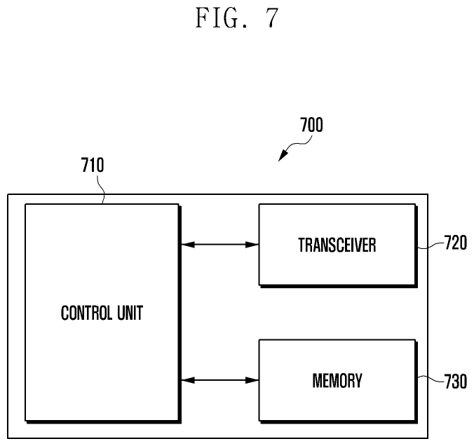

FIG. 7 is a diagram illustrating a structure of a terminal according to an embodiment of the disclosure.

Referring to FIG. 7, a terminal 700 according to an embodiment of the disclosure may be configured to include a control unit 710, a transceiver 720, and memory 730. In the disclosure, the control unit 710 of the terminal 700 may be defined as a circuit or an application-specific integrated circuit or at least one processor.

The control unit 710 may control the overall operation of the terminal 700 according to an embodiment proposed in the disclosure. For example, the control unit 710 may control a signal flow between each block to perform an operation according to the drawings (or, sequence diagram and flow chart) described above.

The transceiver 720 may transmit and receive a signal. For example, the transceiver 720 may transmit a signal to a node or a base station according to an embodiment of the disclosure, and receive the signal from the node or the base station.

The memory 730 may store at least one of the information transmitted and received through the transceiver 720 and the information generated through the control unit 710. In addition, the memory 730 may be defined as a storage unit.

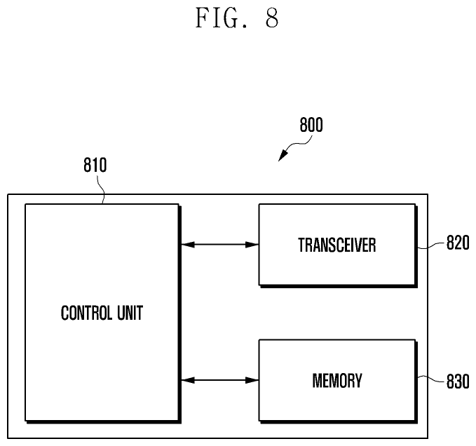

FIG. 8 is a diagram illustrating a structure of a base station according to an embodiment of the disclosure.

Referring to FIG. 8, a base station 800 according to an embodiment of the disclosure may be configured to include a control unit 810, a transceiver 820, and memory 830. In the disclosure, the control unit 810 of the base station 800 may be defined as a circuit or an application-specific integrated circuit or at least one processor.

The control unit 810 may control the overall operation according to an embodiment proposed in the disclosure. For example, the control unit 810 may control a signal flow between each block to perform an operation according to the drawings (or, sequence diagram and flow chart) described above.

The transceiver 820 may transmit and receive signals. The transceiver 820 may transmit a signal to a terminal or node according to an embodiment of the disclosure and receive the signal from the terminal or node.

The memory 830 may store at least one of the information transmitted and received through the transceiver 820 and the information generated through the control unit 810. In addition, the memory 830 may be defined as a storage unit.

In an embodiment of the disclosure, an apparatus and method for effectively providing a service in a wireless communication system may be provided. The technical problems to be achieved by the disclosure are not limited to the above-described technical problems. For example, other technical problems that are not described may be obviously understood by those skilled in the art to which the disclosure pertains from the disclosure.

In an embodiment of the disclosure, an apparatus and method for effectively providing a service in a mobile communication system may be provided. The technical effects according to an embodiment of the disclosure are not limited to the effects described in the disclosure, and other effects not described in the disclosure will be clearly understood by a person having ordinary skill in the art to which the disclosure pertains from the detailed description of the disclosure.

It should be noted that the above-described configuration diagram, example diagram of a control/data signal transmission method, example diagram of an operation procedure, and configuration diagrams are not intended to limit the scope of the disclosure. For example, not all components, entities, or operations described in the embodiments of the disclosure should be construed as essential components for implementing the disclosure, and may be implemented within a scope that does not harm the essence of the disclosure even when only some components are included. In addition, each embodiment may be combined with each other and operated as needed. For example, some of the methods proposed in the disclosure may be combined with each other and operated by the network entity and the terminal.

The operations of the base station or the terminal described above may be realized by providing memory device storing the corresponding program code in any component in the base station or terminal device. For example, the control unit of the base station or terminal device may execute the operations described above by reading and executing the program code stored in the memory device by a processor or a central processing unit (CPU).

Various components and modules, or the like, of the entity, the base station, or the terminal device described in the disclosure may be operated using hardware circuits, such as a complementary metal oxide semiconductor-based logic circuit, firmware, software and/or a combination of hardware and firmware and/or software embedded in a machine-readable medium. For example, various electrical structures and methods may be implemented using electrical circuits, such as transistors, logic gates, and application-specific semiconductors.

Methods according to the embodiments described in the claims or specifications of the disclosure may be implemented in the form of hardware, software, or a combination of hardware and software.

When implemented in software, a computer-readable storage medium storing one or more programs (software modules) may be provided. One or more programs stored in the computer-readable storage medium are configured to be executable by one or more processors in an electronic device. One or more programs include instructions for causing an electronic device to execute methods according to embodiments described in a claim or specification of the disclosure.

Such programs (software modules, software) may be stored in random access memory, non-volatile memory including flash memory, read only memory (ROM), electrically erasable programmable read only memory (EEPROM), magnetic disc storage device, compact disc-ROM (CD-ROM), digital versatile discs (DVDs), any other form of optical storage device, and magnetic cassette. Alternatively, it may be stored in memory including a combination of some or all thereof. In addition, each configuration memory may be included in plurality.

In addition, the program may be stored in an attachable storage device that may accessed through a communication network, such as the Internet, the Intranet, a local area network (LAN), a wide LAN (WLAN), or a storage area network (SAN), or a combination thereof. Such a storage device may be connected to an apparatus implementing an embodiment of the disclosure through an external port. In addition, a separate storage device on the communication network may be connected to the apparatus implementing the embodiment of the disclosure.

In the specific embodiments of the disclosure described above, components included in the disclosure are expressed in the singular or plural according to the specific embodiments presented. However, the singular or plural expression is appropriately selected for the context presented for convenience of description, and the disclosure is not limited to the singular or plural components, and even if the component is expressed in plural, the component is configured in singular or even if the component is expressed in singular, the component may be configured in plural.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage, such as, for example, a storage device like read only memory (ROM), whether erasable or rewritable or not, or in the form of memory, such as, for example, random access memory (RAM), memory chips, device or integrated circuits or on an optically or magnetically readable medium, such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a session management function (SMF) in a communication system, the method comprising:
identifying that a policy and charging control (PCC) rule comprises at least one of first information on a downlink (DL) protocol description or second information on protocol data unit (PDU) set quality of service (QoS) parameters;
in case that the PCC rule comprises the first information and does not comprise the second information, transmitting, to a radio access network (RAN), third information associated with a PDU set information marking; and
receiving, from the RAN, fourth information indicating that a PDU set based handling is supported.

2. The method of claim 1, further comprising:
receiving, from a policy control function (PCF), fifth information on the PCC rule.

3. The method of claim 1, further comprising:
in case that the SMF transmits the third information and receives the fourth information, transmitting, to a PDU session anchor (PSA) user plane function (UPF) (PSA UPF), sixth information associated with a PDU set.

4. The method of claim 1,
wherein the third information comprises a DL PDU set information marking support indication, and
wherein the fourth information comprises a PDU set based handling support indication.

5. A method performed by a radio access network (RAN) in a communication system, the method comprising:
in case that a policy and charging control (PCC) rule comprises first information on a downlink (DL) protocol description and does not comprise second information on protocol data unit (PDU) set quality of service (QoS) parameters, receiving, from a session management function (SMF), third information associated with a PDU set information marking; and
transmitting, to the SMF, fourth information indicating that a PDU set based handling is supported.

6. The method of claim 5, further comprising:
identifying whether the PDU set based handling is supported; and
in case that the PDU set based handling is supported, transmitting, to the SMF, the fourth information.

7. The method of claim 5,
wherein, in case that the RAN receives the third information and transmits the fourth information, sixth information associated with a PDU set is transmitted from the SMF to a PDU session anchor (PSA) user plane function (UPF) (PSA UPF),
wherein the third information comprises a DL PDU set information marking support indication, and
wherein the fourth information comprises a PDU set based handling support indication.

8. The method of claim 5, wherein fifth information on the PCC rule is received by the SMF from a policy control function (PCF).

9. A session management function (SMF) in a communication system, the SMF comprising:
at least one transceiver;
at least one processor communicatively coupled to the at least one transceiver; and
at least one memory, communicatively coupled to the at least one processor, storing instructions executable by the at least one processor individually or in any combination to cause the SMF to:
identify that a policy and charging control (PCC) rule comprises at least one of first information on a downlink (DL) protocol description or second information on protocol data unit (PDU) set quality of service (QoS) parameters,
in case that the PCC rule comprises the first information and does not comprise the second information, transmit, to a radio access network (RAN), third information associated with a PDU set information marking, and
receive, from the RAN, fourth information indicating that a PDU set based handling is supported.

10. The SMF of claim 9, wherein the instructions further cause the SMF to:
receive, from a policy control function (PCF), fifth information on the PCC rule.

11. The SMF of claim 9, wherein the instructions further cause the SMF to:
in case that the SMF transmits the third information and receives the fourth information, transmit, to a PDU session anchor (PSA) user plane function (UPF) (PSA UPF), sixth information associated with a PDU set.

12. The SMF of claim 9,
wherein the third information comprises a DL PDU set information marking support indication, and
wherein the fourth information comprises a PDU set based handling support indication.

13. A radio access network (RAN) in a communication system, the RAN comprising:
at least one transceiver;
at least one processor communicatively coupled to the at least one transceiver; and
at least one memory, communicatively coupled to the at least one processor, storing instructions executable by the at least one processor individually or in any combination to cause the RAN to:
in case that a policy and charging control (PCC) rule comprises first information on a downlink (DL) protocol description and does not comprise second information on protocol data unit (PDU) set quality of service (QoS) parameters, receive, from a session management function (SMF), third information associated with a PDU set information marking, and
transmit, to the SMF, fourth information indicating that a PDU set based handling is supported.

14. The RAN of claim 13, wherein the instructions further cause the RAN to:
identify whether the PDU set based handling is supported, and
in case that the PDU set based handling is supported, transmit, to the SMF, the fourth information.

15. The RAN of claim 13, wherein fifth information on the PCC rule is received by the SMF from a policy control function (PCF).

16. The RAN of claim 13,
wherein, in case that the RAN receives the third information and transmits the fourth information, sixth information associated with a PDU set is transmitted from the SMF to a PDU session anchor (PSA) user plane function (UPF) (PSA UPF),
wherein the third information comprises a DL PDU set information marking support indication, and
wherein the fourth information comprises a PDU set based handling support indication.
